(19) United States
(12) Patent Application Publication
(10) Pub. No.: US 2019/0283994 A1
(43) Pub. Date: Sep. 19, 2019

(54) IMAGE FORMING APPARATUS

(71) Applicant: Konica Minolta Inc., Tokyo (JP)

(72) Inventor: MIKIHIRO YAMAKAWA, Tokyo (JP)

(21) Appl. No.: 16/265,858

(22) Filed: Feb. 1, 2019

(30) Foreign Application Priority Data
Mar. 14, 2018 (JP) 2018-046429

(51) Int. Cl. B65H 7/08; B65H 9/00; B65H 5/06; G03G 15/00

(52) U.S. Cl. CPC B65H 7/08; G03G 15/6529; B65H 5/062; B65H 9/002

(57) ABSTRACT

An image forming apparatus includes: an image forming part that forms an image on a sheet conveyed in a conveying path; a transfer part that transfers the image; a conveying roller that is arranged at the upstream of the transfer part in the conveying path, has rollers, and conveys the sheet to the transfer part; roller drive mechanisms that independently rotate the rollers; a first bend detection sensor that is arranged in the conveying path and detects a bend of a front end of the sheet relative to the conveying direction; a sheet rotation angle calculation part that calculates a first rotation offset angle of the front end of the sheet relative to an axial line of the conveying roller; a roller driving amount calculation part that calculates the driving amounts of the roller drive mechanisms; and a drive mechanism control part that controls operations of the roller drive mechanisms.

The entire disclosure of Japanese patent Application No. 2018-046429, filed on Mar. 14, 2018, is incorporated herein by reference in its entirety.

### BACKGROUND

### Technological Field

The present invention relates to an image forming apparatus including a bend correction function.

### Description of the Related Art

Conventionally, a positional offset in an oblique direction of a sheet is corrected in a sheet conveying path in an image forming apparatus such as a copying machine or printer. The correction is made by providing resist rollers (a pair of rollers) in a conveying path at the upstream of a transfer part for transferring an image onto a sheet and striking a front end of a conveyed sheet onto the resist rollers thereby to temporarily stop the resist rollers (the correction will be denoted as “striking bend correction” below). The sheet which is corrected in its bend at its front end by the striking correction is conveyed to the transfer part. In the striking bend correction, a sheet is fed in a conveying direction while a front end of the sheet is striking on a nip part of the resist rollers, so that “warp” is formed between the front end and the rear end of the sheet and the bend is corrected by elasticity of the sheet.

In an image forming apparatus for double-sided printing, the front and rear ends of a sheet are replaced by an inversion part for switching back both sides of a sheet, and the front end of the back side of the sheet is struck on the resist rollers with the rear end of the top side of the sheet being the front end of the back side of the sheet, thereby making sheet bend correction. The bend-corrected sheet is conveyed to the transfer part.

JP 2017-88265 A describes an image forming apparatus including a line sensor that is configured of a plurality of sensors arranged in a direction tilted relative to a recording medium conveying direction, and a drive unit capable of obliquely rotating a grip roller on the basis of the positional offset amount in the oblique direction of the recording medium sensed by the line sensor. Further, J P 2017-88265 A describes that when a change occurs in a detection result of the line sensor while a recording medium is passing through the line sensor, the drive unit can adjust a rotation angle in the oblique direction of the grip roller depending on the change.

Further, the parallelism is offset between the front end (front edge) and the rear end (rear edge) of a sheet due to cutting in a sheet generation stage, or an image position on a sheet may be offset due to passage through a fixing part. In such a case, a sample is temporarily output (printed), the positions of registration marks formed on the output sheet are measured thereby to estimate a corrected value of the offset component as an average value, and an image to be formed on the sheet is rotated on the basis of the estimated corrected value, thereby correcting the bend.

A further improvement is required in positional accuracy of images between the top side and the back side in double-sided printing in a production printing region in quick printing or the like for bookbinding. When an image forming apparatus including a transfer part and a fixing part is used, for example, in the production printing region, a sheet bend correction position may be limited at a specific position in the apparatus in order to avoid an increase in size of the apparatus. Specifically, resist rollers for making sheet bend correction are provided at a predetermined position at the downstream of an inversion part and at the upstream of the transfer part, for example. Therefore, the striking bend correction using the resist rollers is made on the front end of the back side of the sheet, in which the front and rear ends are replaced in the sheet conveying direction by the inversion part, after the fixing processing on the top side of the sheet in double-sided printing.

The front end of a sheet is subjected to striking bend correction and temporary stop by the resist rollers at the upstream of the transfer part, and thus an acceleration rate of acceleration and deceleration in the resist rollers has to be increased or a linear speed of the entire conveying rollers has to be increased in order to increase productivity. However, the rate of a deceleration time for an operation of temporarily stopping the resist rollers and its subsequent acceleration time increase relative to an operation time in one cycle of continuous operations, and thus a conflicting state is caused in which the inertia of the conveying motors, and a torque margin of motor torque relative to load torque are decreased. That is, the conveying motors operate at a drive resolution achieving productivity during the bend correction operation, and thus the correction accuracy is deteriorated.

### SUMMARY

There has been desired a method for making high-accuracy bend correction of a sheet while further increasing productivity than before in terms of the above situation.

To achieve the abovementioned object, according to an aspect of the present invention, an image forming apparatus reflecting one aspect of the present invention comprises: an image forming part that forms an image on a sheet conveyed in a conveying path; a transfer part that transfers the image formed by the image forming part onto the sheet; a conveying roller that is arranged at the upstream of the transfer part in the conveying path, has a plurality of rollers arranged side by side in a direction orthogonal to a conveying direction of the sheet, and conveys the sheet to the transfer part; a plurality of roller drive mechanisms that independently rotate the rollers constituting the conveying roller; a first bend detection sensor that is arranged in the conveying path and detects a bend of a front end of the sheet relative to the conveying direction; a sheet rotation angle calculation part that calculates a first rotation offset angle of the front end of the sheet relative to an axial line of the conveying roller by use of the detection result of the first bend detection sensor; a roller driving amount calculation part that calculates the respective driving amounts of the roller drive mechanisms on the basis of the first rotation offset angle of the sheet calculated by the rotation angle calculation part such that the bend of the sheet relative to the conveying direction is corrected; and a drive mechanism control part that controls operations of the roller drive mechanisms on the basis of the respective driving amounts of the roller drive mechanisms calculated on the basis of the first rotation offset angle of the sheet, wherein the drive mechanism control part controls such that a drive resolution of the roller drive mechanisms is different between a conveying operation not during a bend correction operation and a conveying operation during a bend correction operation for first bend correction of controlling the operations of the roller drive mechanisms on the basis of the first rotation offset angle of the sheet.

### BRIEF DESCRIPTION OF THE DRAWINGS

The objects, aspects, advantages, and features provided by one or more embodiments of the invention will become more fully understood from the detailed description given hereinbelow and the appended drawings which are given by way of illustration only, and thus are not intended as a definition of the limits of the present invention:

FIG. 1 is an explanatory diagram illustrating an exemplary configuration of an image forming apparatus according to a first embodiment of the present invention;

FIG. 2 is an explanatory diagram illustrating an exemplary configuration of conveying rollers and mechanisms provided near the conveying rollers according to the first embodiment of the present invention;

FIGS. 3A and 3B are explanatory diagrams illustrating an exemplary configuration of rollers according to the first embodiment of the present invention;

FIGS. 4A and 4B are explanatory diagrams illustrating a first bend correction operation and a second bend correction operation according to the first embodiment of the present invention by way of example, respectively;

FIGS. 5A to 5C are explanatory diagrams illustrating exemplary arrangements of a first bend detection sensor and exemplary measurements of a front edge of a sheet by the first bend detection sensor according to the first embodiment of the present invention;

FIG. 6 is a block diagram illustrating an exemplary configuration of a control part in the image forming apparatus according to the first embodiment of the present invention;

FIG. 7 is an explanatory diagram illustrating an exemplary detection value output by use of the first bend detection sensor according to the first embodiment of the present invention;

FIG. 8 is an explanatory diagram illustrating exemplary measurement conditions of a front edge of a sheet according to the first embodiment of the present invention;

FIG. 9 is an explanatory diagram for explaining exemplary calculation of a bend angle (rotation offset angle) at a front edge of a sheet conveyed in an ideal state according to the first embodiment of the present invention;

FIG. 10 is an explanatory diagram illustrating exemplary measurement results of a front edge of a sheet according to the first embodiment of the present invention;

FIG. 11 is an explanatory diagram illustrating an exemplary table of phase excitation methods for motors using an excitation coil according to the first embodiment of the present invention;

FIG. 12 is an explanatory diagram illustrating an exemplary motor specification according to the first embodiment of the present invention;

FIG. 13 is an explanatory diagram illustrating exemplary relationships between correction operation and drive control according to the first embodiment of the present invention;

FIG. 14 is a graph illustrating an exemplary setting of a conveying speed per section according to the first embodiment of the present invention;

FIG. 15 is a table illustrating exemplary relationships between conveying speed and phase excitation per section according to the first embodiment of the present invention;

FIG. 16 is an explanatory diagram illustrating an exemplary configuration of the first and second bend detection sensors according to a variant;

FIG. 17 is an explanatory diagram illustrating exemplary measurements of front edges and rear edges of a sheet by a sheet edge detection sensor according to a second embodiment of the present invention;

FIG. 18 is a block diagram illustrating an exemplary configuration of the control part in the image forming apparatus according to the second embodiment of the present invention;

FIG. 19 is a flowchart (1) illustrating a procedure of image formation processings including sheet bend correction according to the first and second embodiments of the present invention;

FIG. 20 is a flowchart (2) illustrating the procedure of the image formation processings including sheet bend correction according to the first and second embodiments of the present invention; and

FIG. 21 is a time chart illustrating a flow of the image formation processings including sheet bend correction according to the first and second embodiments of the present invention.

### DETAILED DESCRIPTION OF EMBODIMENTS

Hereinafter, one or more embodiments of the present invention will be described with reference to the drawings. However, the scope of the invention is not limited to the disclosed embodiments. Components having substantially the same functions or configurations in the present specification and the accompanying drawings are denoted with the same reference numerals, and a repeated description thereof will be omitted.

### First Embodiment

[Configuration of Image Forming Apparatus]

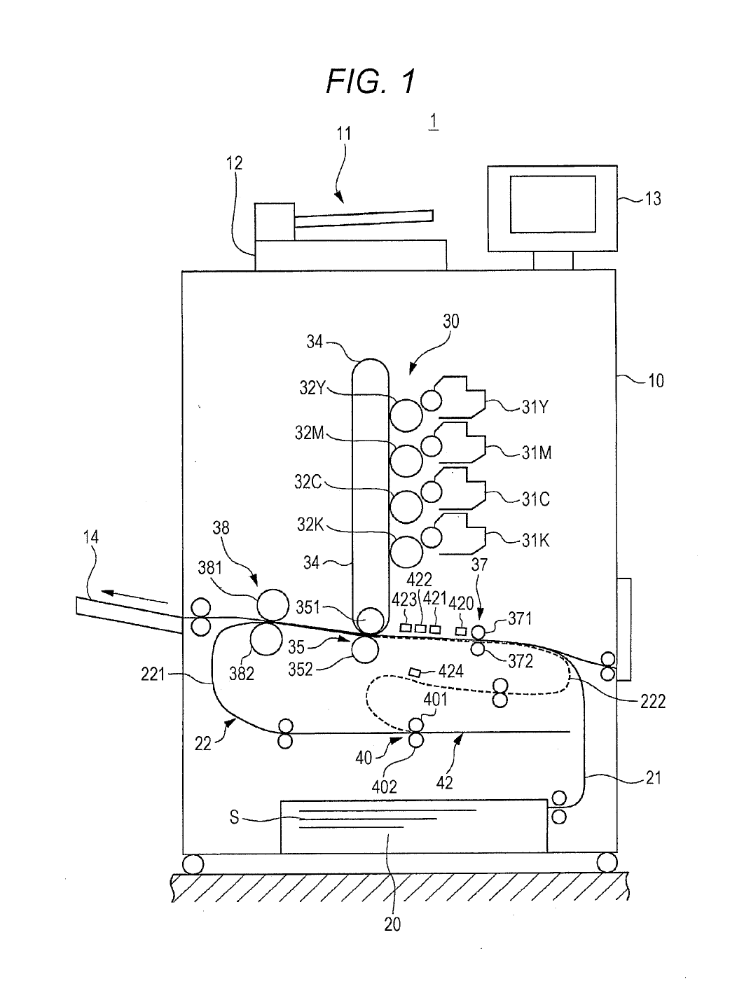

An exemplary configuration of an image forming apparatus 1 according to one embodiment of the present invention will be first described with reference to FIG. 1. FIG. 1 is an explanatory diagram illustrating an exemplary configuration of the image forming apparatus 1 according to one embodiment of the present invention.

The image forming apparatus 1 illustrated in FIG. 1 employs an electrophotographic system for forming an image by use of static electricity, and is a tandem color image forming apparatus for overlapping toner images of four colors of yellow (Y), magenta (M), cyan (C), and black (K), for example.

The image forming apparatus 1 includes an image forming apparatus main body 10, an image input part 11 having an auto document feeder (ADF) 12, an operation display part 13, and a sheet discharging tray 14.

The image input part 11 optically reads an image from a document on a document table of the ADF 12, and A/D converts the read image thereby to generate image data (scanned data).

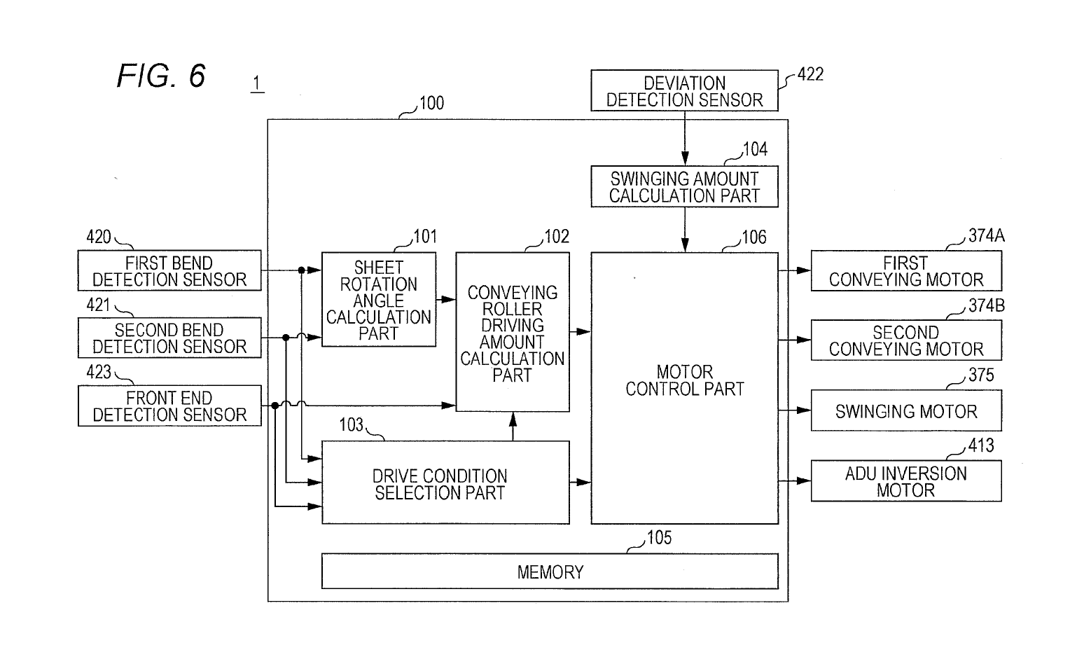

The operation display part 13 is configured of a display part made of a liquid crystal panel or the like, and an operation part made of a touch sensor or the like. The display part and the operation part are integrally formed as a touch panel, for example. The operation display part 13 generates an operation signal indicating the contents of a user's operation input into the operation part, and supplies the operation signal to a control part 100 (see FIG. 6). For example, when the user inputs an operation of instructing to start an image formation processing, the operation display part 13 generates a signal for starting the image formation processing and supplies it to the control part 100. Further, the operation display part 13 displays user's operation contents, setting information, and the like on the display part on the basis of a display signal supplied from the control part 100. The operation part can be configured of a mouse, a tablet, or the like, and can be configured separately from the display part.

The image forming apparatus main body 10 includes a sheet feeding tray 20 and an image forming part 30. The sheet feeding tray 20 is a container containing sheets S on which an image is to be formed in the image forming part 30. Further, a conveying path 21 for conveying a sheet S fed from the sheet feeding tray 20 to the sheet discharging tray 14 is formed in the image forming apparatus main body 10. The conveying path 21 is provided with a plurality of rollers (conveying rollers) for conveying a sheet S. The conveying path 21 further has a double-sided path 22 used for double-sided printing. The double-sided path 22 has a first double-sided path 221 as a conveying path for pulling a sheet S, which has passed through a fixing part 38 described below, into an inversion part 42 described below, the inversion part 42 for replacing (switching back) the front and rear ends of the sheet S conveyed in the first double-sided path 221 in the conveying direction, and a second double-sided path 222 as a path for conveying the sheet S inverted in its top and back sides by the inversion part 42.

The image forming part 30 includes four image forming units 31Y, 31M, 31C, and 31K for forming a toner image of each color of yellow, magenta, cyan, and black. The image forming units 31Y, 31M, 31C, and 31K include charging parts, LED writing units (laser light sources) (not illustrated), photosensitive drums 32Y, 32M, 32C, 32K as image carriers, and development parts (exemplary image forming parts), respectively. When the image forming units 31Y, 31M, 31C, and 31K do not need to be individually discriminated in the following description, the units will be collectively referred to as image forming units 31, and when the photosensitive drums 32Y, 32M, 32C, and 32K do not need to be individually discriminated, they will be collectively referred to as photosensitive drums 32.

The development part forms a latent image on the surface (outer periphery) of the photosensitive drum 32 and attaches a toner containing a wax component supplied from a development device (not illustrated) onto the latent image thereby to form a toner image on the photosensitive drum 32.

The image forming part 30 further includes an intermediate transfer belt 34 (exemplary transfer part) and a secondary transfer part 35 (secondary transfer roller: exemplary transfer part). The intermediate transfer belt 34 is a belt onto which the images formed on the photosensitive drums 32Y, 32M, 32C, and 32K are primarily transferred. The secondary transfer part 35 is a roller for secondarily transferring the toner images of the respective colors primarily transferred onto the intermediate transfer belt 34 onto a sheet S conveyed in the conveying path 21.

A pair of rollers 37 including a driven roller 371 and a driving roller 372 is provided at the upstream of a position where the secondary transfer part 35 is arranged in the conveying path 21. The driving roller 372 has a first roller 372A and a second roller 372B (see FIGS. 3A and 3B) arranged apart at a predetermined interval in the width direction of a sheet S conveyed in the conveying path 21. The first roller 372A is an exemplary first conveying roller, and the second roller 372B is an exemplary second conveying roller. The first roller 372A and the second roller 372B are rotated at mutually-different speeds by conveying motors for rotating and driving them individually, respectively. When the first roller 372A and the second roller 372B are not discriminated or collectively referred, they will be simply referred to as rollers below.

The driven roller 371 is arranged to be able to contact with and release from each roller in the driving roller 372, and the driven roller 371 is driven and rotated along with the rotation operation of the driving roller 372 while contacted with the driving roller 372. Further, a plurality of (two in FIGS. 3A and 3B) rollers of the pair of rollers 37 are driven (swung) by a swinging motor (not illustrated) thereby to move in the sheet width direction. A configuration of the pair of rollers 37 will be described below in detail with reference to FIGS. 3A and 3B.

According to the present embodiment, the pair of rollers 37 makes “bend correction” for correcting an offset in the rotation direction of front edges of a sheet S. An offset in the rotation direction of front edges (exemplary front end) and rear edges (exemplary rear end) of a sheet S is indicated as an angle formed by an axial line of the driving roller 372 (referred to as “conveying roller axial line” below) and the front edges or the rear edges of the sheet S.

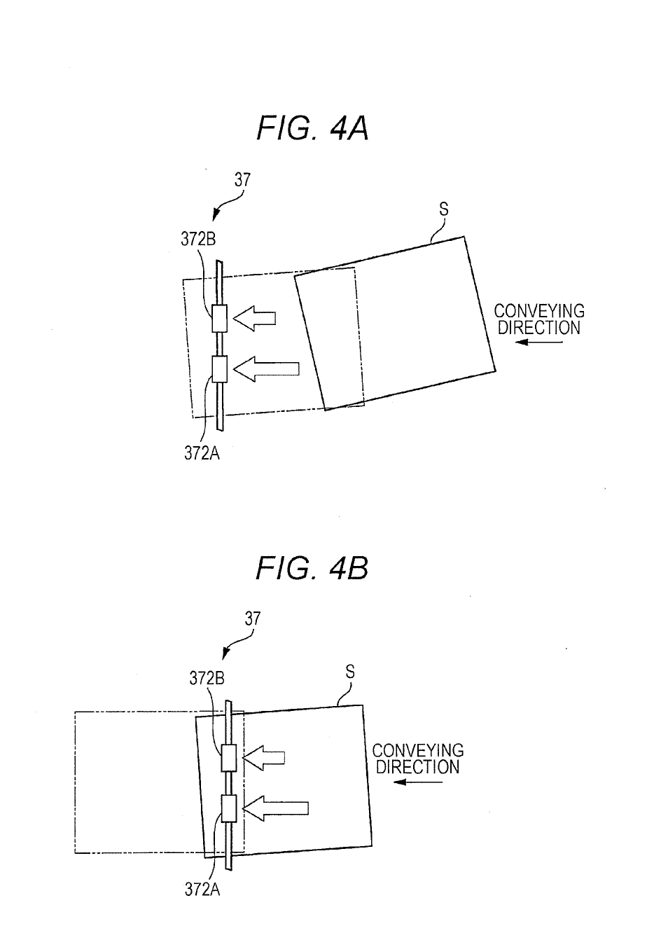

The driven roller 371 and the driving roller 372 in the pair of rollers 37 contact with each other and the conveying motors individually control the rotation speeds of the two rollers 372A and 372B configuring the driving roller 372, respectively, so that the bend correction is made. The bend correction will be described below in detail with reference to FIGS. 4A and 4B. Further, according to the present embodiment, “deviation correction” for correcting a positional offset from the center of a sheet S in the sheet width direction is also made by the pair of first rollers.

As described above, conventionally-used resist rollers (a pair of rollers) are not present at the upstream of the secondary transfer part 35 in the conveying path 21 according to the present embodiment. Thus, according to the present embodiment, striking bend correction using resist rollers, or striking a sheet onto resist rollers while the sheet is being conveyed, and temporary stop of resist rollers are not performed.

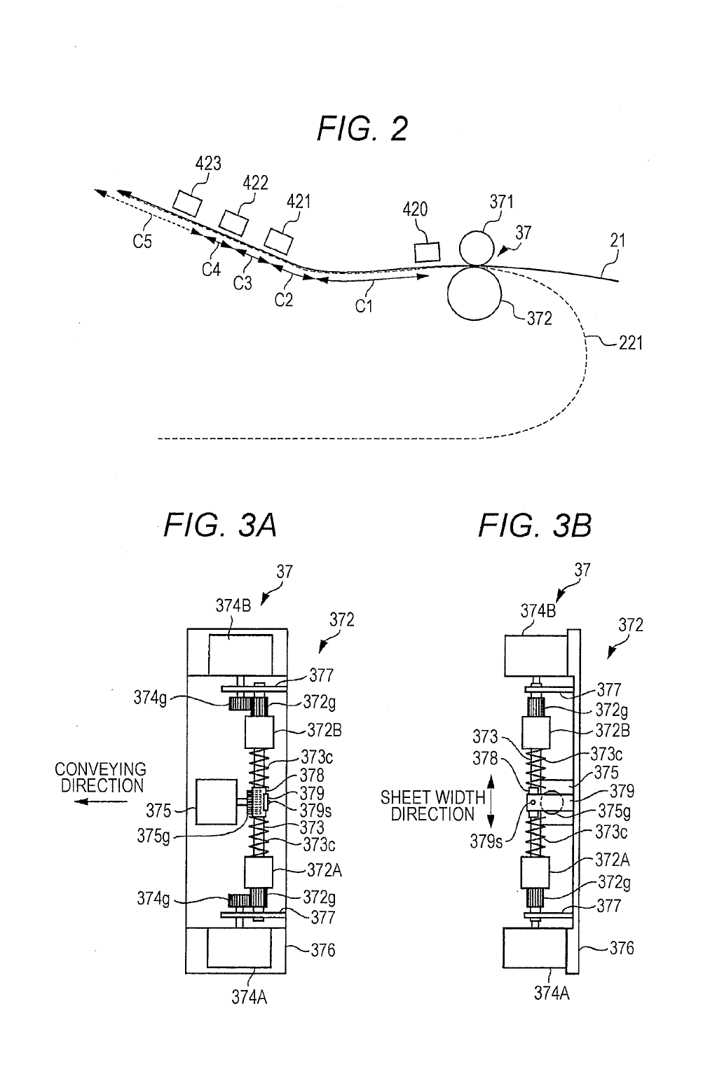

An exemplary configuration of the pair of rollers 37 and mechanisms provided near it will be described herein with reference to FIG. 2. FIG. 2 is an explanatory diagram illustrating an exemplary configuration of the pair of rollers 37 and the mechanisms provided near it.

As illustrated in FIG. 2, a first bend detection sensor 420, a second bend detection sensor 421, a deviation detection sensor 422, and a front end detection sensor 423 are arranged at the downstream of the pair of rollers 37 and at the upstream of the secondary transfer part 35 in the conveying path 21 from the upstream toward the downstream in the conveying direction.

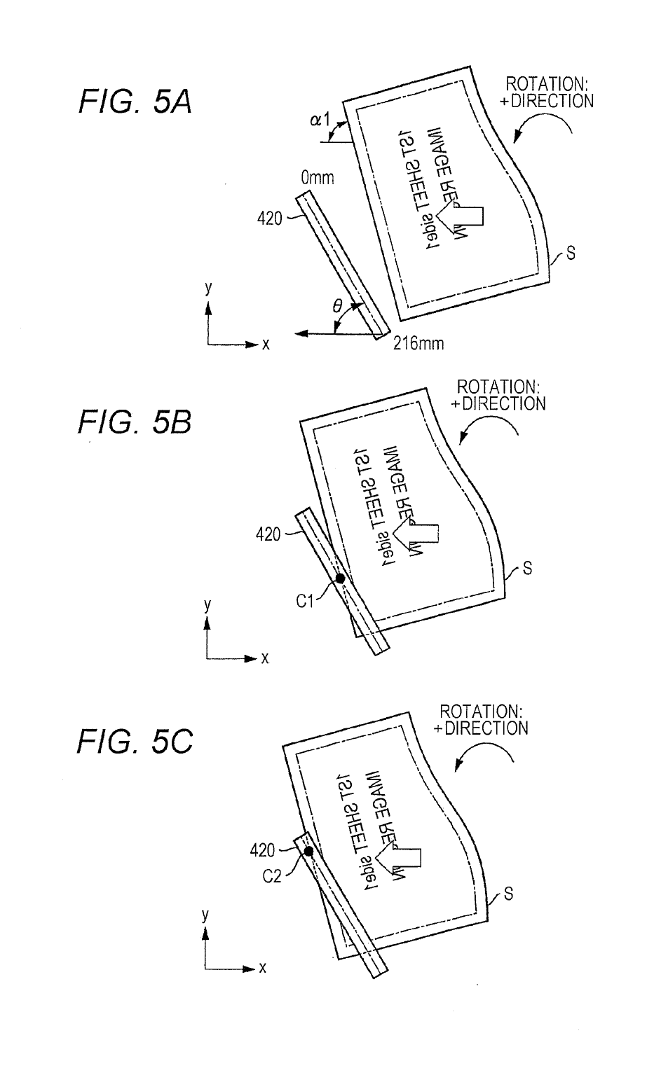

The first bend detection sensor 420 is provided at a predetermined distance away from the pair of rollers 37 at the downstream of the position where the pair of rollers 37 is arranged. The first bend detection sensor 420 is configured of a reflective line sensor, for example, and is installed to be previously tilted relative to the conveying direction at a predetermined angle θ. The first bend detection sensor 420 measures a front edge of a sheet S passing below the sensor at a predetermined time interval or a predetermined feeding step interval of the conveying motors (such as stepping motors) for driving the conveying path 21. The measurement result of the front edge of the sheet S by the first bend detection sensor 420 is output to the control part 100 (see FIG. 6). A configuration of the first bend detection sensor 420 and the edge measurement processing will be described below in detail with reference to FIGS. 4A and 4B, and FIGS. 5A to 5C.

In the example of FIG. 2, the first bend detection sensor 420 is arranged at the downstream of the pair of rollers 37, but is not limited to the example. When the image forming apparatus main body 10 has the double-sided path 22, the first bend detection sensor 420 may be arranged at the upstream of the pair of rollers 37 as long as it is arranged at the downstream of a junction between the conveying path 21 and the double-sided path 22 in the conveying path 21. However, when a distance from the junction between the conveying path 21 and the double-sided path 22 to the pair of rollers 37 is short as illustrated in FIG. 2, the first bend detection sensor 420 is desirably arranged at the downstream of the pair of rollers 37.

The control part 100 calculates the bend amount of the front edge of the sheet S (rotation offset angle relative to the driving roller axial line) on the basis of the measurement result of the first bend detection sensor 420. The control part 100 then calculates the correction amount of first bend correction (linear speed of each roller in the driving roller 372) for the first roller 372A and the second roller 372B on the basis of the calculation result, and selects a phase excitation method. The roller linear speed substantially corresponds to a conveying distance of a sheet S per unit time. The processings of the control part 100 will be described below in detail with reference to FIG. 10.

The second bend detection sensor 421 is provided at a predetermined distance away from the first bend detection sensor 420 at the downstream of the position where the first bend detection sensor 420 is arranged. Similarly to the first bend detection sensor 420, the second bend detection sensor 421 is configured of a reflective line sensor with the same specification as the first bend detection sensor 420, for example, and is installed to be previously tilted relative to the conveying direction at a predetermined angle θ.

The control part 100 calculates the bend amount of the front edge of the sheet S (rotation offset angle relative to the driving roller axial line) on the basis of the measurement result of the second bend detection sensor 421. The control part 100 then calculates the correction amount of second bend correction (linear speed of each roller in the driving roller 372) for the first roller 372A and the second roller 372B on the basis of the calculation result, and selects a phase excitation method.

Further, the deviation detection sensor 422 and the front end detection sensor 423 are provided at the downstream of the position where the second bend detection sensor 421 is arranged. The deviation detection sensor 422 is configured of a reflective line sensor, for example, and is arranged in parallel with the sheet width direction. The deviation detection sensor 422 detects the position of an edge (such as a nearer edge to a viewer of the Figure) in the width direction of the sheet S passing below the sensor, and outputs the detection result to the control part 100 (see FIG. 6). The front end detection sensor 423 is arranged at the further downstream of the position where the deviation detection sensor 422 is arranged, and is configured of a reflective sensor, for example. The front end detection sensor 423 detects a timing when the front end of the sheet S conveyed from the pair of rollers 37 passes, and outputs the detected result to the control part 100.

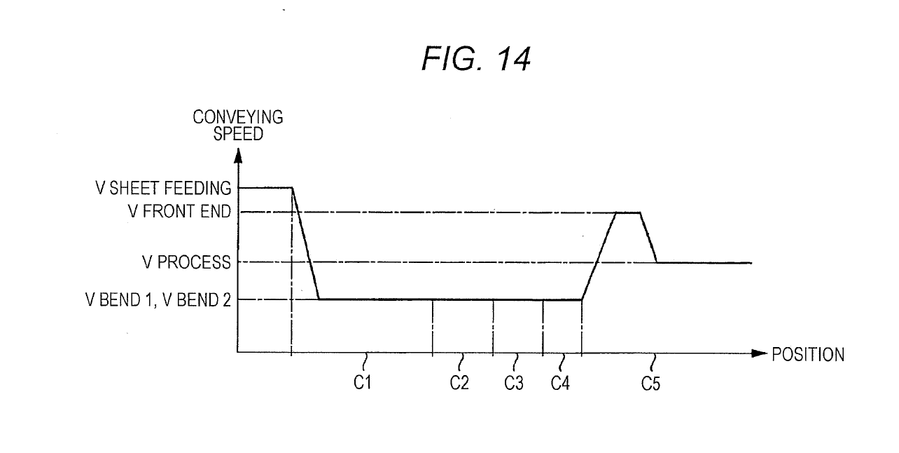

The control part 100 grasps the position (section) of the front edge of the sheet S in the conveying path 21 on the basis of the detection result of each sensor, and controls the conveying speed of the sheet S (linear speed of the driving roller 372). According to the present embodiment, sections C1 to C5 are set depending on a position of the front edge of the sheet S between the pair of rollers 37 and the secondary transfer part 35 in the conveying path 21. As described below, a conveying speed and a phase excitation method are selected depending on the sections (see FIGS. 13 and 14 described below).

The section C1 has the start point at the first bend detection sensor 420 and the end point between the first bend detection sensor 420 and the second bend detection sensor 421 (closer to the second bend detection sensor 421 in FIG. 2). As described below, the section C1 is the section where a sheet S is conveyed at a high conveying speed, and thus is longer than the other sections C2 to C5.

The section C2 is from the end point of the section C1 to the second bend detection sensor 421.

The section C3 is from the start point at the second bend detection sensor 421 to the end point between the second bend detection sensor 421 and the deviation detection sensor 422.

The section C4 is from the end point of the section C3 to a position between the deviation detection sensor 422 and the front end detection sensor 423.

The section C5 ranges toward the downstream of the start point between the deviation detection sensor 422 as the end point of the section C4 and the front end detection sensor 423.

Returning to FIG. 1, the description will be continued. The fixing part 38 is provided at the downstream of the position where the secondary transfer part 35 is arranged in the conveying path 21. The fixing part 38 performs a fixing processing of fixing the images transferred onto the sheet S by the secondary transfer part 35 onto the sheet S.

The fixing part 38 is configured of a fixing upper roller 381 and a fixing lower roller 382 as fixing members, for example. The fixing upper roller 381 and the fixing lower roller 382 are arranged to mutually contact, and a fixing nip part is formed as a contact part between the fixing upper roller 381 and the fixing lower roller 382. A heating part (not illustrated) is provided inside the fixing upper roller 381. A roller part on the outer periphery of the fixing upper roller 381 is heated by heat radiated from the heating part.

The conveying path 21 branches into the conveying path 21 leading to the sheet discharging tray 14 and the double-sided path 22 at the downstream of the position where the fixing nip part of the fixing part 38 is formed. The double-sided path 22 has the first double-sided path 221 for pulling a sheet S into the inversion part 42 and the second double-sided path 222 for conveying the sheet inverted by the inversion part 42 in the conveying path 21 at the upstream of the pair of rollers 37.

The first double-sided path 221 is provided with a pair of rollers 40 as the inversion part 42. The pair of rollers 40 is configured of an auto duplex unit (ADU: inversion unit) inversion roller 401 and a driven roller 402, and the ADU inversion roller 401 is rotated and driven by an ADU inversion motor (see FIG. 6). The pair of rollers 40 pulls a sheet S conveyed in the first double-sided path 221 toward the inversion part 42, and then discharges the sheet S into the second double-sided path 222.

The second double-sided path 222 at the downstream of the inversion part 42 is provided with a sheet edge detection sensor 424 (exemplary third bend detection sensor). The sheet edge detection sensor 424 is configured of a reflective passage detection sensor, for example, and two reflective passage detection sensors are provided in the sheet width direction. Further, the sheet edge detection sensor 424 is arranged perpendicular to the conveying direction. The sheet edge detection sensor 424 detects the positions of front edges and rear edges of a sheet S conveyed in the second double-sided path 222, and outputs the detection results to the control part 100 (see FIG. 6). The control part 100 calculates the sheet S feeding amount (the conveying amount) by each roller configuring the driving roller 372 in order to achieve the desired correction amount of third bend correction on the basis of the information on a temporal difference between the passage times of the sheet S detected by the two sensors in the sheet edge detection sensor 424. The third bend correction using the detection results of the sheet edge detection sensor 424 will be described below in detail according to a second embodiment.

The example in which the sheet edge detection sensor 424 is configured of passage detection sensors is described herein, but the present invention is not limited thereto. The sheet edge detection sensor 424 may be configured of a line sensor (see FIGS. 5A to 5C described below) or an area sensor, for example.

[Exemplary Configuration of Driving Roller in Pair of Rollers]

FIGS. 3A and 3B are explanatory diagrams illustrating an exemplary configuration of the driving roller 372 in the pair of rollers 37. FIG. 3A is a top view, and FIG. 3B is a side view when the driving roller 372 is viewed from the upstream in the conveying direction.

As illustrated in FIGS. 3A and 3B, the mechanisms for rotating and driving the first roller 372A and the second roller 372B configuring the driving roller 372 are axisymmetric to the centerline in the sheet width direction. A configuration for rotating and driving the first roller 372A will be at first described below.

A common rod-shaped shaft 373 arranged in the sheet width direction is axially communicated between the nearer-arranged first roller 372A and the far-arranged second roller 372B. The inner ring of a bearing (not illustrated) having a predetermined length in the axial direction of the shaft 373 is axially supported at a position in the shaft 373 corresponding to the first roller 372A. That is, the shaft 373 is axially communicated to the first roller 372A via the bearing. A conveying roller gear 372g is formed on the first roller 372A at a portion not contacting with the end of the shaft 373 and the inner periphery of the first roller 372A on the outer periphery of the bearing. The conveying roller gear 372g is arranged to mesh with a conveying motor gear 374g.

The conveying motor gear 374g is attached on the rotation shaft of a first conveying motor 374A. The first conveying motor 374A is fixed on a base part 376 having a main face parallel to a sheet S to be conveyed. Attachment plate members 377 are vertically provided on the main face of the base part 376. The rotation shaft of the conveying motor 374A and one end of the shaft 373 are axially borne on the attachment plate member 377. The base part 376 is fixed on a pedestal provided in the image forming apparatus main body 10, or a main body backbone.

With the configuration, when the first conveying motor 374A rotates, its rotation drive force is transmitted to the conveying roller gear 372g via the rotation shaft and the conveying motor gear 374g. Then, when the conveying roller gear 372g rotates, the first roller 372A rotates in a direction in which a sheet S is to be conveyed along with the rotation of the outer ring of the bearing. At this time, the rotation drive force of the conveying roller gear 372g is transmitted only to the roller 372A and is not transmitted to the shaft 373 by the bearing, and thus the shaft 373 does not rotate.

Similarly, the rotation drive force of the second conveying motor 374B is transmitted to the conveying roller gear 372g via the rotation shaft and the conveying motor gear 374g, and the second roller 372B rotates in a direction in which a sheet S is to be conveyed.

The pair of rollers 37 is provided with a mechanism for swinging and driving the driving roller 372. A swinging motor 375 arranged near the center of the base part 376 in the sheet width direction is a drive source for moving the first roller 372A and the second roller 372B configuring the driving roller 372 along the axial line of the shaft 373 (in the sheet width direction). A pinion 375g is attached on the end of the rotation shaft of the driving roller 372, and a tooth part (rack part) is formed on the lower face near the center of the shaft 373 in the sheet width direction. The pinion 375g and the tooth part of the shaft 373 are meshed with each other to be arranged. Rotational movement is converted into linear movement by the pinion 375g and the shaft 373 formed with the tooth part.

With the configuration, when the swinging motor 375 rotates at a predetermined angle, its rotation drive force is transmitted to the shaft 373 via the rotation shaft and the pinion 375g, and the first roller 372A and the second roller 372B move in the sheet width direction along with the movement of the shaft 373. Thereby, a sheet S nipped between the driven roller 371 and the driving roller 372 is moved (swung) in the sheet width direction. At this time, the conveying roller gear 372g moves in the axial direction (thrust direction) of the shaft 373 while meshing with the conveying motor gear 374g.

A guide member 378 is arranged outside the outer periphery of the shaft 373 near the center of the shaft 373 in the sheet width direction. The guide member 378 is substantially cylindrical, but part of the cylindrical face is lacking. That is, an axially-perpendicular cross-section shape of the guide member 378 is an arc-like shape. The guide member 378 is fixed on a fixing member 379 attached on the base part 376 by use of a screw 379s. When the rollers 372A and 372B swing, the shaft 373 is guided and moved by the inner periphery of the substantially-cylindrical guide member 378. The guide member 378 enables the rollers 372A and 372B to be stably swung and driven.

Further, a spring member 373c such as helical spring is wounded between the guide member 378 of the shaft 373 and the first roller 372A (the second roller 372B). Each roller is pressed from the guide member 378 toward the ends of the shaft 373 by a strong force of the spring member 373c. Thereby, a distance between the guide member 378 and each roller is defined, thereby enabling the high-accuracy swinging operation.

[Outline of Bend Correction Operation]

FIGS. 4A and 4B are explanatory diagrams illustrating a first bend correction operation and a second bend correction operation by way of example, respectively. FIG. 4A is a top view illustrating the first bend correction operation and FIG. 4B is a top view illustrating the second bend correction operation.

According to the present embodiment, a conventional sheet front end striking correction operation using resist rollers is not performed, and bend correction by the rollers 372A and 372B arranged in the sheet width direction and independently driving is made twice instead. The rollers 372A and 372B independently rotate under control of a motor control part 106.

As illustrated in FIGS. 4A and 4B, the first bend correction operation and the second bend correction operation are continuously performed while a sheet S is being conveyed. As indicated by an arrow in FIG. 4A, when a sheet S is conveyed to the pair of rollers 37 while rotating (obliquely passing), the control part 100 (see FIG. 6) calculates the linear speeds of the nearer first roller 372A and the far second roller 372B on the basis of the detection result of the first bend detection sensor 420 (see FIG. 2). When the far front edge of the sheet S is faster than the nearer front edge, the control part 100 increases the linear speed of the first roller 372A, and sets the correction amount such that the linear speed of the second roller 372B is lower than the linear speed of the first roller 372A. The lengths of the arrows indicate the linear speeds of the respective rollers.

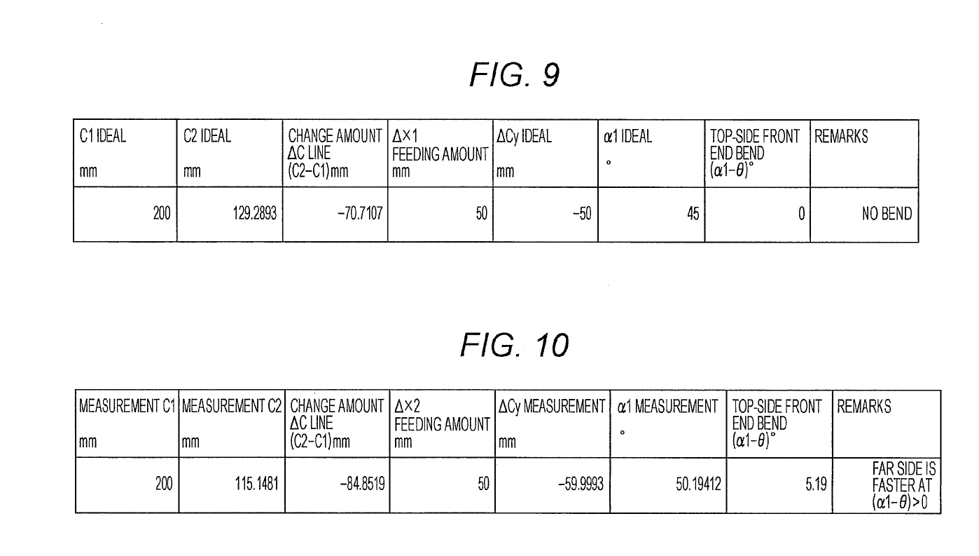

In this way, in the first bend correction, the deceleration timings of a plurality of rollers arranged in the sheet width direction (in the direction perpendicular to the conveying direction) are individually set on the basis of the bend correction angle (α1-θ) (see FIGS. 9 and 10) detected by the first bend detection sensor 420, and the sheet S is rotated to correct the bend of the sheet S by the relative speeds.

In the first bend correction, the conveying speed is set to be higher (than in the second bend correction) and the drive resolution is set to be lower, and thus coarse bend correction is possible. The setting is effective also when a bend is desired to be rapidly corrected (decreased) even by coarse correction.

The first bend correction is then made on the basis of the correction amount and the first bend correction of the sheet S is completed as in a state in a two-dot chain line. In FIG. 4A, the nearer front edge of the sheet S travels faster than the far one, and the rotation (oblique pass) of the sheet S is corrected to be smaller. In this way, the correction amount or the rotation amount of the sheet S is determined depending on a difference between the linear speeds of the first roller 372A and the second roller 372B. As described below, a phase excitation method is set such that the drive resolution of the conveying motors 374A and 374B of the rollers configuring the driving roller 372 in the first bend correction operation is higher than in the case where the bend correction operation is not performed.

When the sheet S is still rotating (obliquely passing) after the first bend correction operation is performed, the second bend correction operation is subsequently performed. The second bend correction operation is similar to the first bend correction operation. As illustrated in FIG. 4B, the control part 100 (see FIG. 6) calculates the linear speeds of the nearer first roller 372A and the far second roller 372B on the basis of the detection result of the second bend detection sensor 421 (see FIG. 2). In the example of FIG. 4B, the control part 100 increases the linear speed of the first roller 372A, and sets the correction amount such that the linear speed of the second roller 372B is lower than the linear speed of the first roller 372A. The lengths of the arrows indicate the linear speeds of the respective rollers. The bend is eliminated from the sheet S in a two-dot chain line on which the second bend correction is completed.

In this way, in the second bend correction, the deceleration timings of a plurality of rollers arranged in the sheet width direction (in the direction perpendicular to the conveying direction) are individually set on the basis of the bend correction angle (α1-θ) (see FIGS. 9 and 10) detected by the second bend detection sensor 421, and the sheet S is rotated to correct the bend of the sheet S by the relative speeds.

The conveying speed in the second bend correction is set to be lower than that in the first bend correction, and the drive resolution is set to be higher than that in the first bend correction, and thus higher-accuracy bend correction is possible than in the first bend correction.

Further, as described below, a phase excitation method is set such that the drive resolution of the conveying motors 374A and 374B of the rollers configuring the driving roller 372 is higher in the second bend correction operation than that in the first bend correction operation.

In the examples of FIGS. 4A and 4B, bend correction is made twice, but may be made three times or more. In this case, the conveying speed and the drive resolution are selected such that a relationship between the drive resolution of the conveying motors and required torque is established in each bend correction. According to the present embodiment, bend correction is made twice due to the arrangement of the sensors in the conveying path 21 and conveying distances in the first bend correction and the second bend correction.

[Exemplary Arrangements of Bend Detection Sensor and Exemplary Edge Measurements]

FIGS. 5A to 5C are explanatory diagrams illustrating exemplary arrangements of the first bend detection sensor 420 and exemplary measurements of a front edge of a sheet S by the first bend detection sensor 420. The description will be made herein for the first bend detection sensor 420, but the second bend detection sensor 421 is basically the same as the first bend detection sensor 420, and thus the description for the second bend detection sensor 421 will be omitted.

In the examples of FIGS. 5A to 5C, the first bend detection sensor 420 is configured of a line sensor having a length of 216 mm, and is obliquely arranged relative to the sheet S conveying direction (the x direction in the Figures) by an angle θ such as 45°. The length of the first bend detection sensor 420 illustrated in FIGS. 5A to 5C is exemplary, and other lengths may be employed. The tilt angle θ of the first bend detection sensor 420 may be other than 45° as long as it is larger than the maximum angle assumed as the bend amount of the sheet S.

The first bend detection sensor 420 scans between one end and the other end of the first bend detection sensor 420 thereby to detect the edges of a sheet S passing below the first bend detection sensor 420. As illustrated in FIGS. 5A to 5C, the sheet S passing below the first bend detection sensor 420 via the double-sided path 22 in double-sided printing is formed with an image on the top side (first side), and its top and back sides are inverted so that the back side faces upward.

In the examples of FIGS. 5A to 5C, assuming the far end in the sheet width direction (in the y direction in the Figures) or the position of 0 mm as the origin, the first bend detection sensor 420 scans from the origin toward the position of 216 mm at the nearer end in the sheet width direction.

The first bend detection sensor 420 scans a sheet S conveyed at a constant conveying speed at predetermined time intervals or at feeding step intervals of the conveying motors (not illustrated) several times as described above. In the examples of FIGS. 5A to 5C, the first bend detection sensor 420 detects a front edge of the sheet S twice.

FIG. 5A illustrates a positional relationship between the first bend detection sensor 420 and the sheet S when the front end of the back side (second side) of the sheet S returned into the conveying path 21 via the double-sided path 22 reaches the first bend detection sensor 420. FIG. 5B illustrates a positional relationship between the first bend detection sensor 420 and the sheet S when the first bend detection sensor 420 makes the first measurement of the front edge of the sheet S. As illustrated in FIG. 5B, the position of a tip C1 of the front edge of the sheet S is measured in the first measurement of the front edge of the sheet S.

FIG. 5C illustrates a positional relationship between the first bend detection sensor 420 and the sheet S when the first bend detection sensor 420 makes the second measurement of the front edge of the sheet S. As illustrated in FIG. 5C, the position of a tip C2 of the front edge of the sheet S is measured in the second measurement of the front edge of the sheet S.

The control part 100 (see FIG. 6) calculates the bend angle of the front edge of the sheet S (the rotation offset angle relative to the conveying roller axial line) on the basis of the position information of the tip C1 and the tip C2 measured by the first bend detection sensor 420. The control part 100 then determines the correction amount (the linear speed of each roller in the driving roller 372) for the sheet S (the back side of the sheet S in the examples of FIGS. 5A to 5C) passing through the first bend detection sensor 420 on the basis of the calculated information.

The examples of FIGS. 5A to 5C assume that the first bend detection sensor 420 measures the front edge of a sheet S twice, but the present invention is not limited thereto. The first bend detection sensor 420 may measure the front edge of a sheet S any number of times more than twice.

[Configuration of Control System in Image Forming Apparatus]

An exemplary configuration of the control part 100 in the image forming apparatus 1 will be described below with reference to FIG. 6. FIG. 6 is a block diagram illustrating an exemplary configuration of the control part 100 in the image forming apparatus 1. The same components as in FIG. 1 are denoted with the same reference numerals in FIG. 6, and the repeated description thereof will be omitted.

The control part 100 includes a sheet rotation angle calculation part 101, a conveying roller driving amount calculation part 102, a driving condition selection part 103, a swinging amount calculation part 104, a memory 105, and the motor control part 106 (exemplary drive mechanism control part). The control part 100 is a controller for controlling the image forming apparatus 1, and is configured of a semiconductor integrated circuit (control board) by way of example.

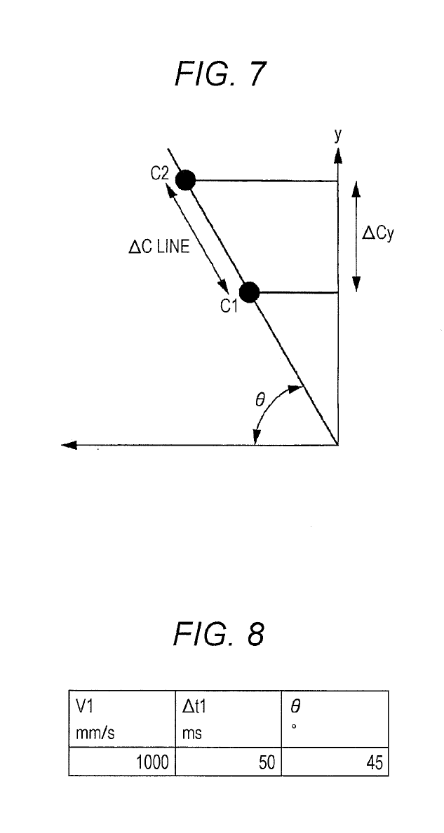

The sheet rotation angle calculation part 101 calculates a bend angle of a front edge or a rotation offset angle to be corrected on the basis of the measurement information on the front edge of the sheet S detected by the first bend detection sensor 420 and the second bend detection sensor 421. The bend angle of the front edge of the sheet S is calculated as an offset angle in the rotation direction relative to the conveying roller axial line. The sheet rotation angle calculation part 101 outputs the information on the calculated rotation offset angle to the conveying roller driving amount calculation part 102. A method for calculating a bend angle of a front edge of a sheet S by the sheet rotation angle calculation part 101 will be described below in detail with reference to FIGS. 7 to 10.

The conveying roller driving amount calculation part 102 acquires the bend angle (rotation offset angle) of the front edge of the sheet S from the sheet rotation angle calculation part 101, and the conveying speed (exemplary driving condition) from the driving condition selection part 103. The conveying roller driving amount calculation part 102 then calculates the respective rotation amounts (the respective driving amounts) of the rollers 372A and 372B configuring the driving roller 372 in the first or second bend correction on the basis of the bend angle (rotation offset angle) of the front edge of the sheet S and the conveying speed. The conveying roller driving amount calculation part 102 outputs the information on the calculated driving amounts to the motor control part 106.

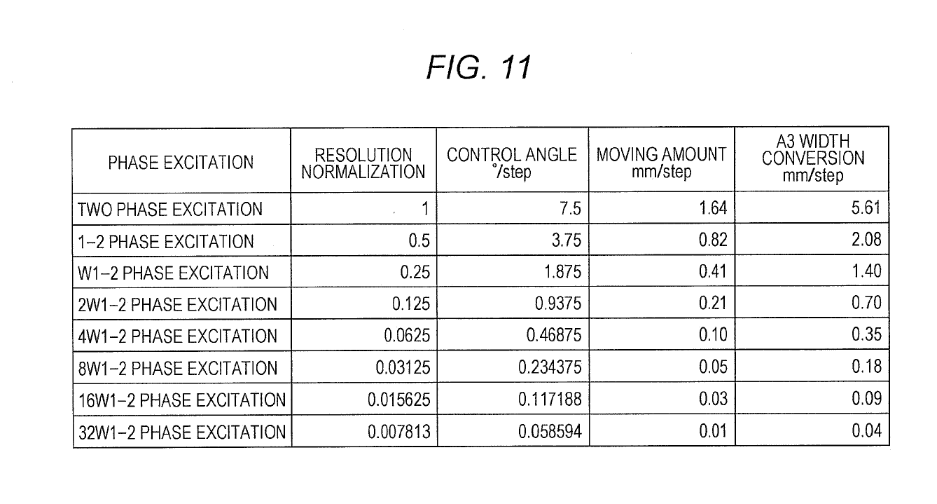

The driving condition selection part 103 selects the driving conditions including the conveying speeds (linear speeds) of the conveying motors 374A and 374B and a phase excitation method from the measurement information of the front edge of the sheet S detected by the first bend detection sensor 420 and the second bend detection sensor 421, and the detection result of the front end detection sensor 423. Combinations of a conveying speed and a phase excitation method (see FIG. 14 described below) for the sections C1 to C5 (see FIG. 2) in the conveying path 21 are assumed to be previously stored as driving condition candidates in the nonvolatile memory 105. The driving condition selection part 103 outputs the selected driving conditions to the motor control part 106 and the conveying roller driving amount calculation part 102. The driving conditions may include at least a relationships between each of the sections C1 to C5 in the conveying path 21 and a phase excitation method (drive resolution). The driving condition selection method by the driving condition selection part 103 will be described below in detail with reference to FIGS. 11 to 15.

The swinging amount calculation part 104 calculates the moving amount (swinging amount) toward the conveying roller axial direction of the driving roller 372 during deviation correction on the basis of a state of the edge position of an end of the sheet S in the width direction detected by the deviation detection sensor 422. When the side edge position of the sheet S detected by the deviation detection sensor 422 is offset relative to an ideal position by +Δy, for example, the swinging amount calculation part 104 calculates the correction amount by which the driving roller 372 can be swung and moved by −Δy toward the conveying roller axial line. The swinging amount calculation part 104 outputs the information on the calculated swinging amount to the motor control part 106.

The motor control part 106 drives the first roller 372A and the second roller 372B configuring the driving roller 372 on the basis of the driving conditions input from the driving condition selection part 103, the information on the driving amount calculated by the conveying roller driving amount calculation part 102, and the information on the swinging amount calculated by the swinging amount calculation part 104. Specifically, the motor control part 106 controls the operations of the first conveying motor 374A, the second conveying motor 374B, and the swinging motor 375. The motor control part 106 further controls the operations of an ADU inversion motor 413 in double-sided printing.

[Exemplary Calculation of Bend Angle of Sheet Front Edge by Sheet Rotation Angle Calculation Part]

Exemplary calculation of a bend angle of a front edge of a sheet S by the sheet rotation angle calculation part 101 will be described below with reference to FIGS. 7 to 10. FIG. 7 is an explanatory diagram illustrating an exemplary detected value output by use of the first bend detection sensor. FIG. 8 is an explanatory diagram illustrating exemplary measurement conditions of a front edge of a sheet S. FIG. 9 is an explanatory diagram for explaining exemplary calculation of a bend angle (rotation offset angle) of a front edge of a sheet S conveyed in an ideal state. FIG. 10 is an explanatory diagram illustrating exemplary measurement results of a front edge of a sheet S.

The examples of FIGS. 7 to 10 describe that the first bend detection sensor 420 is configured of the line sensor illustrated in FIGS. 5A to 5C. The line sensor illustrated in FIGS. 5A to 5C has a length of 216 mm, and is arranged to be tilted at 45° relative to the conveying direction. Hereinafter, the first bend detection sensor 420 will be described by way of example, but the same is applied to the second bend detection sensor 421.

As illustrated in FIG. 7, the measured coordinate values of the tips C1 and C2 of the sheet S on the first bend detection sensor 420 are projected onto the y coordinates thereby to calculate the changing amount ΔCy (y-axis projection length) in the y direction, and the angle α1 of the front edge for calculating the bend angle of the sheet S (see FIG. 5A) is calculated. In FIG. 7, the 4C line is a difference between the coordinates read by the first bend detection sensor 420. The changing amount ΔCy of the measurement points in the y direction can be found in the following Equation (1).

ΔCy=(length of ΔC line)×sin θ Equation (1)

The measurement conditions for a front edge of a sheet S will be described herein with reference to FIG. 8. FIG. 8 illustrates the measurement conditions including a conveying speed V1 in the conveying path 21 of “1000 mm/s,” a measurement interval Δt1 of a front edge of a sheet S by the first bend detection sensor 420 of “50 ms,” and a tilt angle θ relative to the conveying direction of the first bend detection sensor 420 of “45°” by way of example.

Exemplary calculation of a bend angle (rotation offset angle) of a front edge of a sheet S conveyed in an ideal state will be described below with reference to FIG. 9. FIG. 9 illustrates that the position of the tip C1 detected in the first measurement of a front edge by the first bend detection sensor 420 is 200 mm from the point of origin of 0 mm, and the position of the tip C2 detected in the second measurement is 129.2893 mm from the point of origin. Therefore, the length of the ΔC line as a difference between the tip C2 and the tip C1 (C2−C1) is “−70.7107.”

The feeding amount Δx1 in the x direction and the changing amount ΔCy in the y direction of the sheet S conveyed at an interval of one measurement by the first bend detection sensor 420 are calculated to be “50 mm,” respectively, on the basis of the parameters. ΔCy is denoted as “−50 mm” in FIG. 9. The feeding amount 4×1 and the changing amount ΔCy in the y direction are achieved in the ideal state, and when the values are measured, the front edge and the rear edge of the sheet S are parallel with each other and no rotation of the sheet S is detected. The orientation of the sheet S is an orientation of the front edge of the sheet S expected to be obtained by correction.

The sheet rotation angle calculation part 101 calculates the changing amount ΔCy in the y direction from the position of the tip C1 to the position of the tip C2, and finds arctangent between the changing amount ΔCy and the feeding amount 4×1 in the x direction in the ideal state, thereby calculating the angle α1 of the front edge of the sheet S. The changing amount ΔCy in the y direction can be found as a difference in the y direction between the position of the tip C2 and the position of the tip C1. Thus, the changing amount ΔCy in the y direction is “−50 mm” from Equation (1). The feeding amount Δx1 in the ideal state is “50 mm” as illustrated in FIG. 8. Here, the angle α1 of the front edge can be found in the following Equation (2).

Angle α1=tan⁻¹(|ΔCy|/Δx1) Equation (2)

Each value is substituted into Equation (2), and thus the ideal angle α1=45° is found. The sheet rotation angle calculation part 101 then calculates a difference between the angle α1 found in Equation (1) and the bend angle of the front edge, or the arrangement angle θ of the first bend detection sensor 420 thereby to find the bend angle of the front edge of the top side of the sheet S or the angle to be corrected (bend correction angle) (α1-θ). The bend correction angle (α1-θ) is (45-45)°=0° in the ideal state, and bend correction is not required.

Exemplary measurement results of a front edge of a bent sheet S will be described below with reference to FIG. 10. FIG. 10 illustrates that the position of the tip C1 of the front edge detected in the first measurement by the first bend detection sensor 420 is 200 mm from the point of origin of 0 mm, and the position of the tip C2 detected in the second measurement is 115.1481 mm from the point of origin. At this time, the length of the ΔC line is “−84.8519” and the changing amount ΔCy in they direction is found to be “−59.9993” from Equation (1). Each value is then substituted into Equation (2), and thus the angle α1=50.19412° of the front edge is found.

Therefore, the bend correction angle (α1-θ) is (50.19412−45)°=5.19°. When the bend angle (α1-θ) of the front edge is larger than “0°,” the tilt of the front edge of the sheet S may be such that the far (upper in the Figure) end of the sheet in the x direction is earlier conveyed than the nearer end (the far end is faster).

[Exemplary Calculation of Bend Angle of Sheet Front Edge by Sheet Rotation Angle Calculation Part]

Exemplary selection of driving conditions of the first conveying motor 374A and the second conveying motor 374B by the driving condition selection part 103 (or resolution selection part) will be described below with reference to FIGS. 11 to 15.

FIG. 11 is an explanatory diagram illustrating an exemplary table indicating the kinds of phase excitation methods for motors using an excitation coil.

The table illustrated in FIG. 11 has a phase excitation field, a resolution normalization field, a control angle field, a moving amount field, and an A3 width conversion value [mm/step].

The phase excitation field registers the kind of phase excitation.

The resolution normalization field registers a value of relative drive resolution of phase excitation to be compared assuming drive resolution of two-phase excitation at “1.”

The control angle field registers a rotation angle [°/step] per step of the stepping motor.

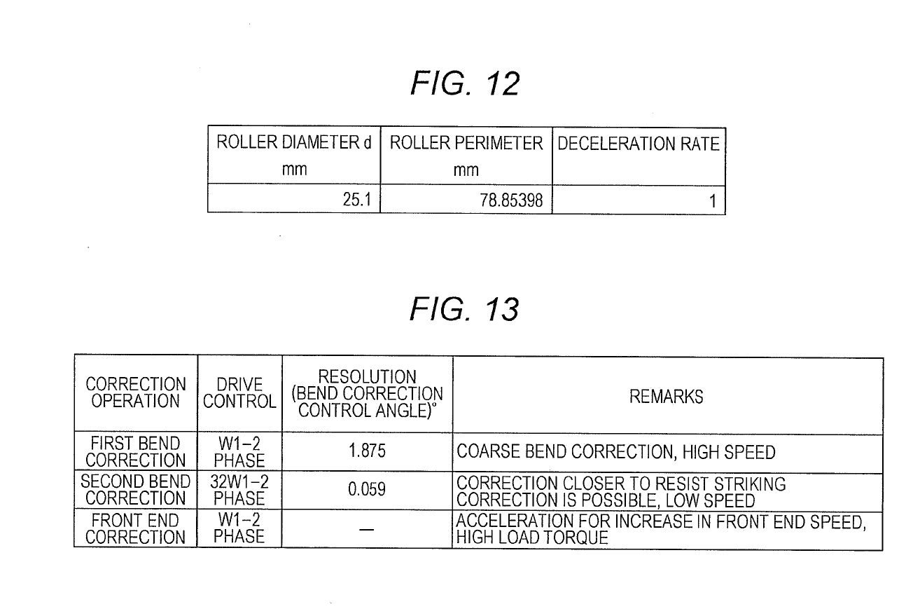

The moving amount field registers a length [mm/step] of rotated arc per step of the stepping motor. The moving amount can be calculated from the control angle, and the roller diameter d[mm], the roller perimeter [mm], and the deceleration rate of each of the rollers 372A and 372B illustrated in FIG. 12. In the example of FIG. 12, the roller diameter d is “25.1 mm,” the roller perimeter is “78.85398 mm,” and the deceleration rate of the conveying motor gear 374g and the conveying roller gear 372g is “1.”

The A3 width conversion filed registers a value [mm/step] obtained by converting the moving amount of the stepping motor into the moving amount of an A3-sized sheet.

In FIG. 11, phase excitations such as two-phase excitation, 1-2 phase excitation, W1-2 phase excitation, 2W1-2 phase excitation, 4W1-2 phase excitation, 8W1-2 phase excitation, 16W1-2 phase excitation, and 32W1-2 phase excitation are registered. The drive resolution is higher in this order of phase excitation. According to the present embodiment, two-phase excitation is used during normal conveying and the first bend correction. Further, 32W1-2 phase excitation is used during the second bend correction (during self-activation before an increase in speed of sheet front end). An operation state of the stepping motors is in the self-activation region during the automatic activation operation of the stepping motors.

Other phase excitation may be used in consideration of a relationship between conveying speed and drive resolution. According to the present embodiment, it is desirable that at least the drive resolution of phase excitation during the second bend correction is higher than the drive resolution of phase excitation during the first bend correction.

FIG. 13 is an explanatory diagram illustrating exemplary relationships between correction operation (bend correction operation) and driving control according to the present embodiment.

As described also in FIG. 11, “W1-2 phase excitation” is used for driving control during the first bend correction, and the drive resolution (control angle) is “1.875°” at this time. In this case, coarse bend correction is made and the conveying speed is high. The force of holding the sheet S by the pair of rollers 37 is low at this time.

“32W1-2 phase excitation” is used for driving control during the second bend correction, and the drive resolution (control angle) is “0.059°” at this time and is lower than the drive resolution during the first bend correction. In this case, higher-accuracy bend correction closer to the striking correction by resist rollers is possible, and the conveying speed is lower than that during the first bend correction. The force of holding the sheet S by the pair of rollers 37 at this time is higher than that during the first bend correction.

Further, “W1-2 phase excitation” is used for driving control during front end correction. The front end correction is directed to adjust a timing when the sheet S is conveyed to the secondary transfer part 35 for the toner images carried in the intermediate transfer belt 34, and thus the drive resolution is not so problematic. Thus, the conveying speed, which is lowered for bend correction, is increased for an increase in speed of the front end and load torque is increased during the front end correction.

The drive resolution is appropriately switched according to the kind of correction in this way, thereby achieving both bend correction and front end correction. Phase excitation may be switched to other phase excitation such as “4W1-2 phase excitation” in the range where the load torque, the correction accuracy, and the conveying speed are achieved. Further, the phase expiation method and the number of times of bend correction may be changed depending on the sheet type of sheet S to be conveyed, rigidity, environment conditions such as temperature and humidity inside or outside the image forming apparatus 1, or conditions such as process linear speed.

[Exemplary Settings of Conveying Speed Per Section]

FIG. 14 is a graph illustrating exemplary settings of the conveying speed for each of the sections C1 to C5 (see FIG. 2) in the conveying path 21.

It is assumed herein that the conveying speed when the front edge of the sheet S reaches the first bend detection sensor 420 is “V sheet feeding” (exemplary sheet feeding speed), and the conveying speeds when the front edge of the sheet S reaches the second bend detection sensor 421 is “V bend 1” (in top-side printing) and “V bend 2” (in back-side printing) (exemplary bend correction speeds). It is further assumed that the conveying speed when the second bend correction operation is completed is “V bend 1” (in top-side printing) and “V bend 2” (in back-side printing), the conveying speed when the front edge of the sheet S reaches the front end detection sensor 423 is “V front end” (exemplary front end speed), and the process linear speed during transfer in the secondary transfer part 35 is “V process” (exemplary process speed). At this time, a relationship of the conveying speeds is set as “V sheet feeding>V front end>V process>V bend 1, V bend 2.” The relationship of the conveying speeds in the sections C1 to C5, and the transition of the conveying speeds are illustrated in the graph of FIG. 14. In the section C5, the conveying speed is increased from “V bend 1 (V bend 2)” to “V front end,” the front end of the sheet S is corrected for the image, and then the conveying speed is decreased to “V process.”

[Examples of Conveying Speed and Phase Excitation Per Section]

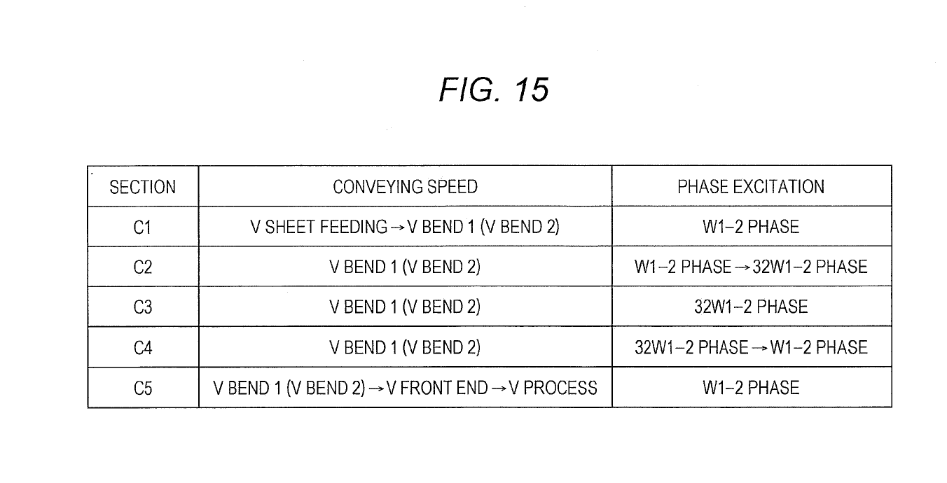

FIG. 15 is a table illustrating exemplary relationships between conveying speed and phase excitation per section in the conveying path 21.

The table of FIG. 15 collectively describes the setting of driving control (phase excitation) illustrated in FIG. 13 and the setting of conveying speed for each of the sections C1 to C5 illustrated in FIG. 14, and is a driving condition table indicating the driving conditions per section. The driving condition table includes a section field, a conveying speed field, and a phase excitation field. The driving condition table is stored in the nonvolatile memory 105 (see FIG. 6), for example, and is read by the driving condition selection part 103.

As illustrated in FIG. 15, it is assumed, according to the present embodiment, that each sensor or conveying speed meets a position and a temporal relationship the position and the time that the first bend correction operation is completed before the sheet S reaches the second bend detection sensor.

Further, the drive resolution of each conveying motor 374 driving the driving roller 372 is switched such that the resolution is higher in the second bend correction than in the first bend correction while the sheet S is being conveyed at high-speed V bend 2 (in back-side printing, for example) from the completion of the first bend correction to the start of the second bend correction. For example, W1-2 phase excitation is switched to 32W1-2 phase excitation.

Further, the drive resolution of each conveying motor 374 driving the driving roller 372 is switched to be returned from the phase excitation during the second bend correction to the phase excitation during the first bend correction while the sheet S is being conveyed at lower-speed V bend 2 than during the first bend correction from the completion of the second bend correction to the start of the front end correction. For example, 32W1-2 phase excitation is switched to W1-2 phase excitation.

As described above, the present embodiment is configured such that the control angle (operation angle) of the conveying motors 374A and 374B is variable in the conveying mechanism including the rollers 372A and 372B arranged side by side at a predetermined interval in the sheet width direction. At first, the linear speed of the conveying motors 374A and 374B is decreased to a predetermined speed (such as self-activation region of the stepping motors) until the sheet S reaches the second bend detection sensor 421. Then, the phase excitation is switched in the speed-decreased state (self-activation region, for example) thereby to switch the normal speed (in the first bend correction) to a speed (in the second bend correction) at which high-accuracy bend correction is made. Then, the phase excitation is switched again thereby to return from the speed (in the second bend correction) at which high-accuracy bend correction is made to the normal speed (normal conveying speed). Thereafter, the sheet S is conveyed toward the secondary transfer part 35 without being stopped, and the front end correction operation for the sheet S is started at a predetermined timing.

The configuration enables the conventional resist rollers to be eliminated According to the present embodiment, the sheet S is pressed by the pair of rollers 37 thereby to be subjected to front end correction and to be swung until the completion of the front end correction after the sheet S is conveyed to the nip part of the pair of rollers 37 (the driven roller 371 and the driving roller 372).

[Variant of First and Second Bend Detection Sensors]

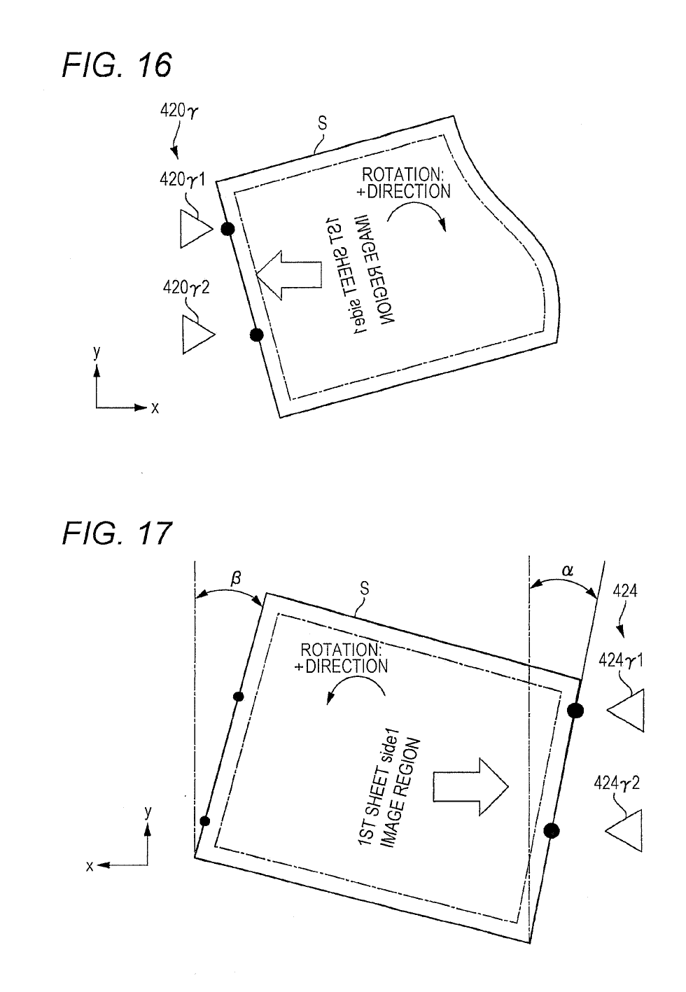

An Exemplary Configuration of First and Second Bend Detection Sensors According to a Variant Will be described below with reference to FIG. 16. FIG. 16 is an explanatory diagram illustrating an exemplary configuration of first and second bend detection sensors according to the variant. In the variant illustrated in FIG. 16, a first bend detection sensor 420γ is configured of passage detection sensors 420γ1 and 420γ2 arranged side by side at a predetermined interval in the sheet width direction (in the y direction in the Figure). The number of passage detection sensors is not limited to two, and may be three or more.

The passage detection sensors 420γ1 and 420γ2 measure front edges of a sheet S, respectively. The sheet rotation angle calculation part 101 (see FIG. 6) acquires the passage timings of the front edges of the sheet S conveyed in the second double-sided path 222 (before the back-side image is transferred) through the passage detection sensors 420γ1 and 420γ2, and calculates the bend angle of the front edges of the sheet S based on the difference.

[Various Effects]

According to the first embodiment, in correcting the sheet bend, the first bend correction with high drive resolution (low motor holding force due to high conveying speed and high motor holding force due to low drive resolution) is made and the second bend correction with high resolution (high motor holding force due to low conveying speed and low motor holding force due to high drive resolution) is made. Thus, according to the present embodiment, the bend correction corresponding to the conventional striking to resist rollers can be made at high accuracy while the torque required for the conveying motors is secured.

Further, according to the present embodiment, temporary stop of resist rollers is not required unlike before due to the two-phase bend corrections (the first bend correction and the second bend correction). Thus, the acceleration time and the temporary stop time are not required and the productivity is improved. Thereby, the average speed at which the sheet S is conveyed can be decreased or the acceleration rate of acceleration and deceleration may not be increased without sacrifice of the torque margin of the conveying motors.

Further, according to the present embodiment, the phase excitation method is switched between a region with high conveying speed and high load and a region with low conveying speed (near self-activation region) and low load, and thus sheets can be conveyed with the required holding force secured.

A combination of drive resolution and conveying speed is considered as a conveying motor driving condition according to the above embodiment, but the drive resolution may be switched at least during the bend correction operation and not during the same. That is, there is configured such that the control part 100 controls the drive resolution of the conveying motors 374 to be different between in the conveying operation not during the bend correction operation and in the conveying operation during the bend correction operation for the first bend correction for controlling the operations of the conveying motors 374 on the basis of the rotation offset angle (the first rotation offset angle) of the sheet S by the first bend detection sensor 420.

With the configuration, there is acquired an effect in which the bend correction by a plurality of rollers arranged in the sheet width direction can be made at high accuracy while the torque required for the corresponding conveying motors is secured.

### Second Embodiment

For example, it is assumed that an accuracy of cutting during sheet generation is low or parallelism is offset between the front end and the rear end of a sheet due to sheet deformation or the like by the fixing processing on the top side of the sheet. In this case, when the striking correction using resist rollers is made with reference to the front end of the back side of the sheet, the image position to be formed on the back side is offset from the image position formed on the top side by the parallelism offset between the front and rear ends of the sheet.

For example, the grip roller for correcting a positional offset in the oblique direction of a recording medium is provided at the upstream of the fixing part in the technique described in JP 2017-88265 A, and thus a parallelism offset between the front end and the rear end of a sheet, which is caused after the fixing processing on the top side of the sheet, cannot be corrected with the technique described in JP 2017-88265 A.

For example, when an offset component correction value as an average value is estimated and an image to be formed on a sheet is rotated by use of the estimated correction value thereby to make bend correction, the bend state in an individual sheet cannot be determined, and thus a bend due to a variation in an individual sheet cannot be corrected.

Thus, there will be described, according to the second embodiment, an example in which the sheet edge detection sensor 424 (the third bend detection sensor) is provided in the double-sided path 22 in the image forming apparatus 1 (see FIG. 1) according to the first embodiment thereby to detect front edges and rear edges of a sheet S.

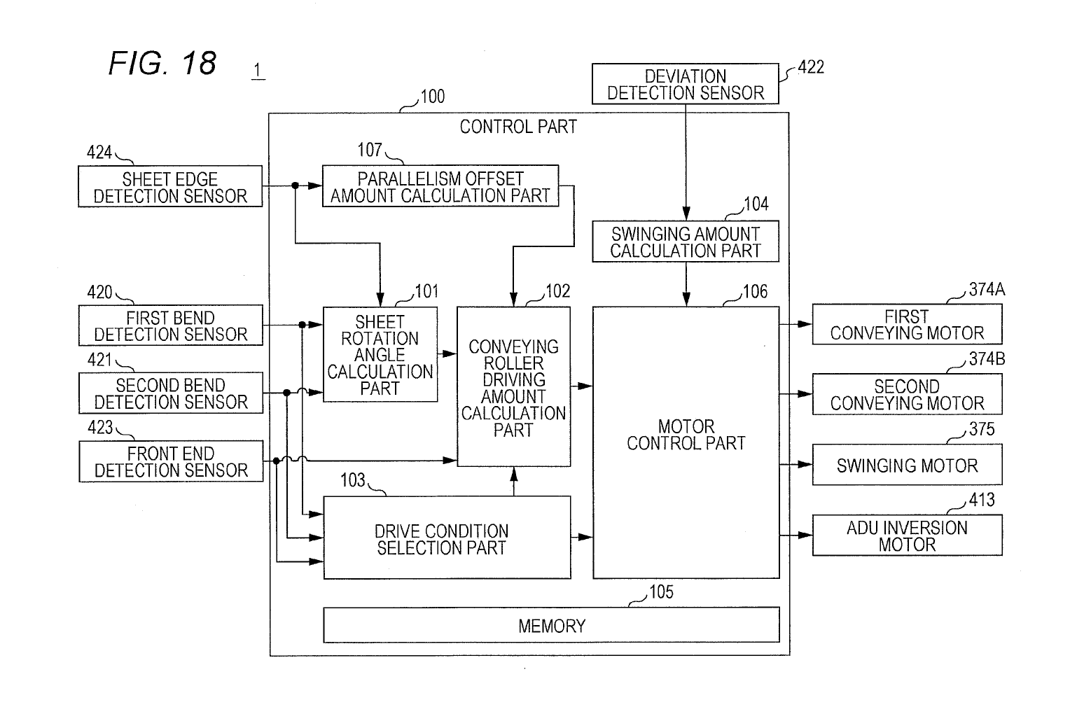

A method for detecting front edges and rear edges of a sheet S by the sheet edge detection sensor 424 will be described below with reference to FIGS. 17 and 18. FIG. 17 is an explanatory diagram illustrating exemplary measuring front edges and rear edges of a sheet S by the sheet edge detection sensor 424. FIG. 18 is a block diagram illustrating an exemplary configuration of the control part 100 in the image forming apparatus 1 according to the second embodiment.

The sheet edge detection sensor 424 is arranged in the second double-sided path 222 (see FIG. 1) provided at the downstream of the inversion part 42 in the double-sided path 22. A shorter distance between detection of the front edges and rear edges of a sheet S by the sheet edge detection sensor 424 and bend correction by the pair of rollers 37 is better, and thus the sheet edge detection sensor 424 is desirably arranged in the second double-sided path 222. However, the position of the sheet edge detection sensor 424 is not limited to the example, and the sheet edge detection sensor 424 may be provided in the first double-sided path 221 at the upstream of the inversion part 42. The sheet edge detection sensor 424 is configured of passage detection sensors 424γ1 and 424γ2 arranged side by side at a predetermined interval in the sheet width direction (in the y direction in the Figure). The passage detection sensors 424γ1 and 424γ2 have the same specification as the passage detection sensors 420γ1 and 420γ2 of FIG. 16.

When the sheet edge detection sensor 424 is arranged in the second double-sided path 222 provided at the downstream of the inversion part 42, a sheet S passing below the sheet edge detection sensor 424 is a sheet S in which the image formation on the top side is completed and both sides are inverted, or a sheet S with the image formed on the top side.

The passage detection sensors 424γ1 and 424γ2 measure the front edges of the sheet S, respectively. The sheet rotation angle calculation part 101 (see FIG. 18) acquires the passage timings of the front edges and the rear edges of the sheet S conveyed in the second double-sided path 222 through the passage detection sensors 424γ1 and 424γ2, and calculates the bend angles of the front edges and the rear edges of the sheet S based on the difference.

The control part 100 in the image forming apparatus 1 illustrated in FIG. 18 is different from the control part 100 of FIG. 6 in that a parallelism offset amount calculation part 107 is provided. The parallelism offset amount calculation part 107 calculates the offset amounts of parallelism of the front edges and the rear edges of the sheet S on the basis of the detection results of the sheet edge detection sensor 424, and outputs the calculated results to the conveying roller driving amount calculation part 102.

Exemplary bend detection of a sheet S passing through the passage detection sensors 424γ1 and 424γ2, and a relationship between the first bend detection by the first bend detection sensor 420 at the downstream, and bend correction will be described herein.

At first, the control part 100 (see FIG. 18) detects the bends of the front edges and the rear edges of a passing sheet S by the passage detection sensors 424γ1 and 424γ2. A value including the rotation amount of the sheet S by the sheet rotation angle calculation part 101 and the parallelism offset between the front and rear ends of the sheet S by the parallelism offset amount calculation part 107 is detected herein.

The control part 100 calculates the bend amount of the front edges (the rear edges during top-side transfer of the sheet S) of the passing sheet S by the sheet rotation angle calculation part 101, and assumes it as an angle “α°.”

Further, the control part 100 calculates a bend of the rear edges of the passing sheet S as the rotation amount of the sheet S by the sheet rotation angle calculation part 101, and assumes it as an angle “β°.”

Further, the parallelism offset amount calculation part 107 in the control part 100 calculates the parallelism offset amount (parallelism offset angle) of the front edges and the rear edges of the sheet S as the deformation amount of the sheet S on the basis of a difference between both the bend amounts, and assumes it as a deformation amount θ=“(β·α)°.” The information on the deformation amount θ is input into the conveying roller driving amount calculation part 102.

Thereafter, the front end of the sheet S reaches the first bend detection sensor 420. The rotation amount of the sheet S can change while the sheet S is being conveyed to the first bend detection sensor 420.

The control part 100 then detects the bend amount of the front edges (the rear edges during top-side transfer of the sheet S) of the sheet S passing through the first bend detection sensor 420 by the sheet rotation angle calculation part 101, and assumes it as an angle “γ°.”

The control part 100 then calculates the first bend correction amount from the detection result (the third bend detection result) by the sheet edge detection sensor 424 and the detection result (the first bend detection result) by the first bend detection sensor 420 by the sheet rotation angle calculation part 101 and the conveying roller driving amount calculation part 102 and performs the first bend correction operation. At this time, the bend amount Δ° to be corrected is the amount for changing the bend amount of the rear end of the sheet S to 0°, and thus is found as Δ=β+(γ−α).

Thereafter, the front end of the sheet S reaches the second bend detection sensor 421. The sheet rotation angle calculation part 101 in the control part 100 calculates the bend amount of the front edges (the rear edges during top-side transfer of the sheet S) of the passing sheet S by the second bend detection sensor 421, and assumes it as an angle “σ°.” The control part 100 then calculates the second bend correction amount from the third bend detection result and the second bend detection result by the conveying roller driving amount calculation part 102, and performs the second bend correction operation. At this time, the bend amount Δ′° to be corrected is the amount for changing the bend amount of the rear end of the sheet S to 0°, and is found as Δ′=β+(σ−α).

In this way, when the first bend detection sensor 420 or the second bend detection sensor 421 detects the bend of the front end of the sheet S joining up with the conveying path 21 from the double-sided path 22 and makes the first bend correction or the second bend correction, the conveying roller driving amount calculation part 102 controls the bend correction operation such that the parallelism offset angle detected by the sheet edge detection sensor 424 is compensated for by the bend correction amount of the sheet S. In other words, the conveying roller driving amount calculation part 102 assumes a difference between the bend amount of the front edges of the sheet S by the sheet edge detection sensor 424 and the bend amount of the front end of the sheet S by the first bend detection sensor 420 or the second bend detection sensor 421 as a change in the bend amount of the sheet S during back-side printing relative to the sheet S during top-side printing in double-sided printing, and controls the rear edges of the sheet S during back-side printing to be parallel to the image.

According to the second embodiment described above, the bend correction operations of the top side of the sheet S and the back side of the sheet S in double-sided printing are performed with reference to the same ends of the same sheet S (the front edges of the back side of the sheet S and the rear edges of the top side of the sheet S). Therefore, the image position accuracy of the top side and the back side of the sheet S improves.

<Image Formation Processing Method Including Sheet Bend Correction>

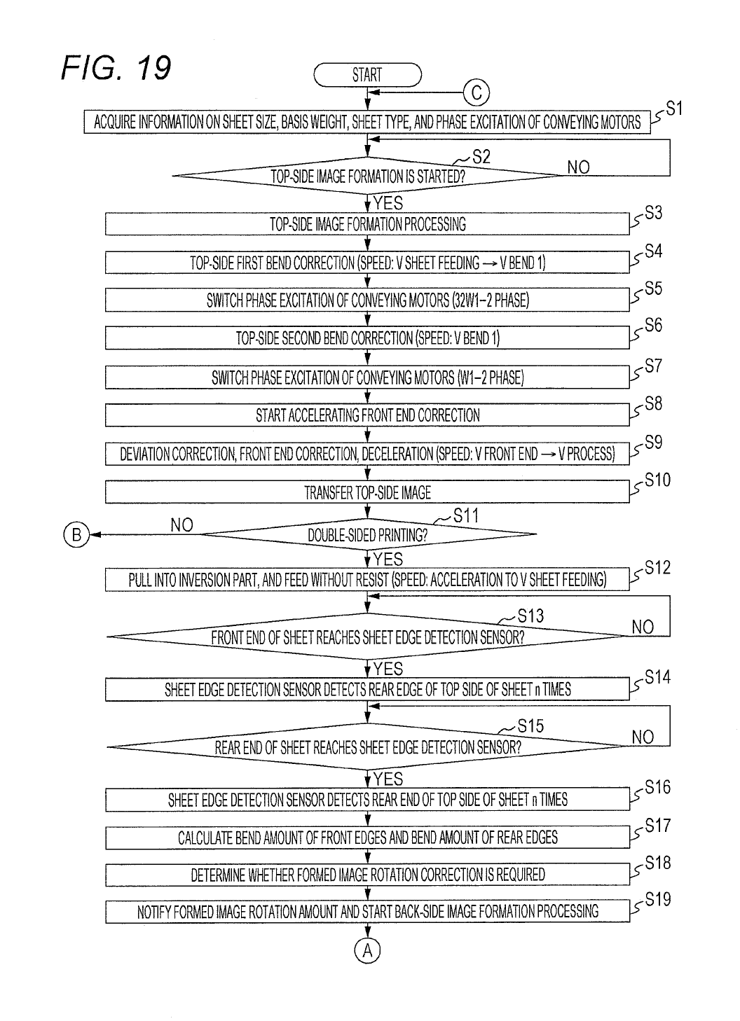

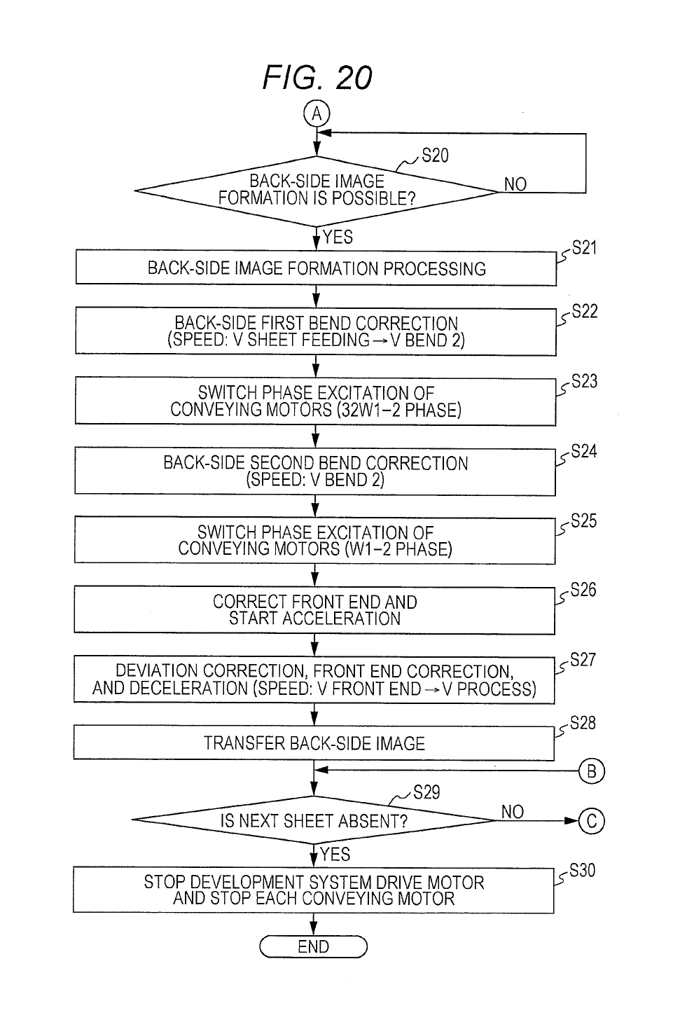

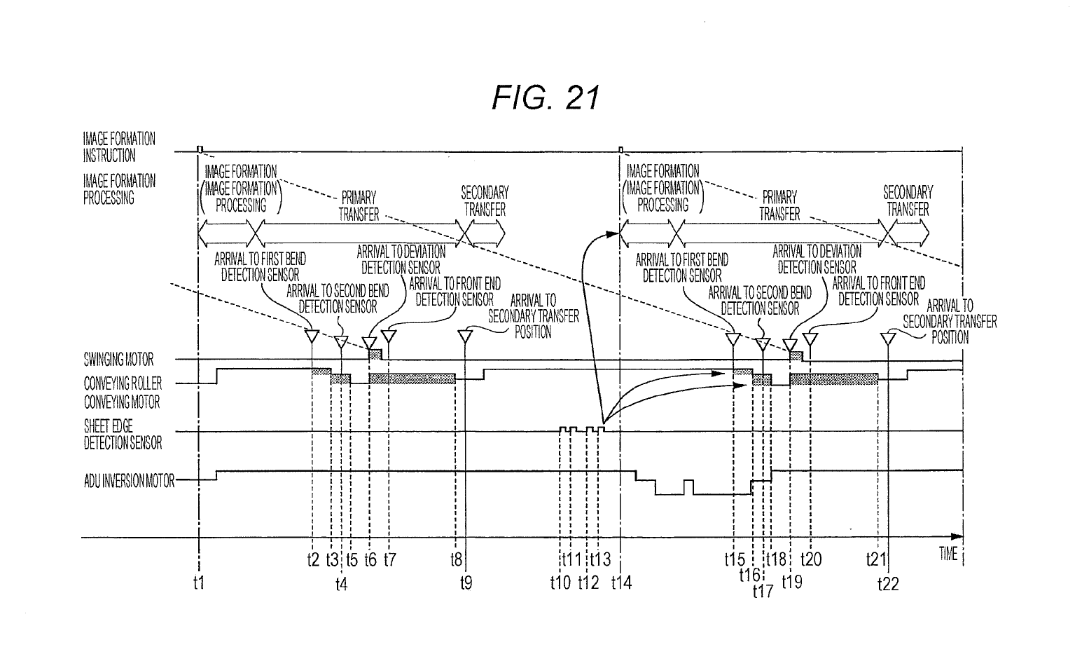

An image formation processing method including sheet bend correction by the image forming apparatus 1 will be described below with reference to FIGS. 19 to 21. FIGS. 19 to 21 illustrate contents including both the first embodiment and the second embodiment. FIG. 19 is a flowchart (1) indicating a procedure of the image formation processings including sheet bend correction. FIG. 20 is a flowchart (2) indicating the procedure of the image formation processings including sheet bend correction. FIG. 21 is a time chart indicating a flow of the image formation processings including sheet bend correction according to the first embodiment of the present invention.

A procedure of the image formation processing method including sheet bend correction by the image forming apparatus 1 will be first described with reference to FIG. 19.

At first, the control part 100 acquires the information on the sheet size, the basis weight, and the sheet type of a sheet S, and the conveying motor phase excitation (the initial value is “W1-2 phase excitation” according to the present embodiment) (step S1). The control part 100 then determines whether it has received a signal for instructing to start forming an image on the top side of the sheet S (image formation processing) (step S2). In step S2, when it is determined that the signal for instructing to start the image formation processing has not been received (NO in step S2), the control part 100 repeatedly makes the determination in step S2.

On the other hand, in step S2, when it is determined that the signal for instructing to start the image formation processing has been received (YES in step S2), the control part 100 performs a processing of forming a top-side image to be formed on the top side of the sheet S (step S3). The control part 100 then rotates the two rollers 372A and 372B configuring the driving roller 372 at the mutually-different rotation speeds thereby to make the first bend correction (denoted as “top-side first bend correction” in the Figure) of the top side of the sheet S (step S4). Here, the control part 100 decreases the conveying speed from “V sheet feeding” to “V bend 1.”

The control part 100 then switches the phase excitation of the first conveying motor 374A and the second conveying motor 374B from W1-2 phase excitation to 32W1-2 phase excitation, for example (step S5). The first conveying motor 374A and the second conveying motor 374B are denoted as conveying motors 374A and 374B, respectively.

The control part 100 then makes the second bend correction (denoted as “top-side second bend correction” in the Figure) of the top side of the sheet S (step S6). Here, the control part 100 maintains the conveying speed at “V bend 1.”

The control part 100 then switches the phase excitation of the conveying motors 374A and 374B from W1-2 phase excitation to 32W1-2 phase excitation, for example (step S7). The control part 100 then proceeds to the front end correction operation, and increases the conveying speed of the sheet S from “V bend 1” to “V front end” (step S8). The control part 100 then makes the deviation correction and the front end correction of the sheet S (step S9). Here, the control part 100 decreases the conveying speed from “V front end” to “V process.”

The secondary transfer part 35 then transfers the top-side image onto the sheet S (step S10). The control part 100 then determines whether an instruction for double-sided printing has been made as a job (step S11). In step S11, when the instruction for double-sided printing has not been made (NO in step S11), the processing proceeds to connector B. The processings after connector B will be described below with reference to FIG. 20.

In step S11, when it is determined that the instruction for double-sided printing has been made (YES in step S11), the control part 100 controls the inversion part 42 to pull the sheet S into the inversion part 42, and then feeds the sheet S to the second double-sided path 222 without the resist operation (step S12). Here, the control part 100 increases the conveying speed from “V process” to “V sheet feeding.”

The control part 100 then determines whether the front end of the top side of the sheet S has reached the position where the sheet edge detection sensor 424 is arranged (step S13). In step S13, when it is determined that the front end of the top side of the sheet S has not reached the position where the sheet edge detection sensor 424 is arranged (NO in step S13), the control part 100 repeatedly makes the determination in step S13. On the other hand, when it is determined that the front end of the top side of the sheet S has reached the position where the sheet edge detection sensor 424 is arranged (YES in step S13), the control part 100 causes the sheet edge detection sensor 424 to measure the front edges of the top side of the sheet S n times (n is a natural number of 1 or more) (step S14).

The control part 100 then determines whether the rear end of the top side of the sheet S has reached the position where the sheet edge detection sensor 424 is arranged (step S15). In step S15, when it is determined that the rear end of the top side of the sheet S has not reached the position where the sheet edge detection sensor 424 is arranged (NO in step S15), the control part 100 repeatedly makes the determination in step S15. On the other hand, when it is determined that the rear end of the top side of the sheet S has reached the position where the sheet edge detection sensor 424 is arranged (YES in step S15), the control part 100 causes the sheet edge detection sensor 424 to measure the rear edges of the top side of the sheet S n times (step S16).

The sheet rotation angle calculation part 101 in the control part 100 then calculates the bend amount (angle) of the front edges of the top side of the sheet S and the bend amount (angle) of the rear edges thereof on the basis of the measurement results of the sheet edge detection sensor 424 in steps S14 and S16 (step S17).

The control part 100 then determines whether the formed image rotation correction needs to be made on the basis of the information on the respective bend angles of the front edges and the rear edges of the top side of the sheet S calculated in step S17 (step S18).

The sheet rotation angle calculation part 101 then notifies the formed image rotation amount as the correction amount in the formed image rotation correction to the image forming part 30, and the image forming part 30 starts the back-side image formation processing of forming an image on the back side of the sheet S (step S19).

After the processing in step S19, the control part 100 determines whether image formation on the back side of the sheet S is possible (step S20 in FIG. 20). The control part 100 determines that image formation on the back side of the sheet S is possible when it is determined that a rotation abnormality or shape abnormality does not occur on the sheet S in determining necessity of the formed image rotation correction in step S19 of FIG. 19.

In step S20, when it is determined that image formation on the back side of the sheet S is not possible (NO in step S20), the control part 100 repeatedly makes the determination in step S20.

On the other hand, in step S20, when it is determined that image formation on the back side of the sheet S is possible (YES in step S20), the control part 100 causes the image forming part 30 to perform the processing of forming a back-side image to be formed on the back side of the sheet S (step S21).

The control part 100 then rotates the two rollers 372A and 372B configuring the driving roller 372 at mutually-different rotation speeds thereby to make the first bend correction (denoted as “back-side first bend correction” in the Figure) of the back side of the sheet S with reference to the rear edges of the back side of the sheet S (step S22). Here, the control part 100 decreases the conveying speed from “V sheet feeding” to “V bend 2.”

The control part 100 then switches the phase excitation of the conveying motors 374A and 374B from W1-2 phase excitation to 32W1-2 phase excitation, for example (step S23). The control part 100 then causes the second bend correction (denoted as “back-side second bend correction” in the Figure) to be made on the back side of the sheet S with reference to the rear edges of the back side of the sheet S (step S24). Here, the control part 100 maintains the conveying speed at “V bend 2.”

The control part 100 then switches the phase excitation of the conveying motors 374A and 374B from 32W1-2 phase excitation to W1-2 phase excitation, for example (step S25). The control part 100 then proceeds to the front end correction operation thereby to increase the conveying speed of the sheet S from “V bend 1” to “V front end” (step S26).

The control part 100 then makes deviation correction and front end correction of the sheet S (step S27). Here, the control part 100 decreases the conveying speed from “V front end” to “V process.” The secondary transfer part 35 then transfers the back-side image onto the sheet S (step S28).

After the processing in step S28 or when it is determined that an instruction for double-sided printing has not been made in step S11 of FIG. 19 (NO in step S11), the control part 100 determines whether a next sheet to be subjected to image formation is not present (step S29). In step S29, when it is determined that a next sheet is absent (YES in step S29), the control part 100 stops the driving motors and the conveying motors in the development system for the development processing (step S30). In step S29, when it is determined that a next sheet is not absent (NO in step S29), the control part 100 returns to the processing in step S1 of FIG. 19. After the processing in step S30, the image formation processing by the image forming apparatus 1 ends.

A flow of the image formation processings including sheet bend correction by the image forming apparatus 1 will be described below with reference to the time chart of FIG. 21. The time chart of FIG. 21 illustrates the timings to input an image forming instruction and the processing timings of the image formation processings by the image forming part 30 from the top. The time chart of FIG. 21 further illustrates exemplary operations of the first conveying motor 374A, the second conveying motor 374B, the swinging motor 375, and the ADU inversion motor 413. The horizontal axis of FIG. 21 indicates time.

In the example of FIG. 21, at first, when an instruction to form a top-side image is input into the image forming part 30 (t1), the image formation (image formation processing) by the image forming part 30 is started. Thereafter, the image forming part 30 performs primary transfer and secondary transfer. Then, when the sheet S conveyed in the conveying path 21 reaches the position of the first bend detection sensor 420 (t2), the conveying speed is decreased from “V sheet feeding” to “V bend 1,” and the first bend correction is made on the front end of the top side of the sheet S (between t2 and t3).

The front end of the top side of the sheet S reaches the position of the second bend detection sensor 421 (t4), and the second bend correction is made on the front end of the top side of the sheet S between t5 when a predetermined time elapses from t4 and t6.

Then, the front end of the top side of the sheet S reaches the position of the deviation detection sensor 422 at time t6 (t6), and the deviation correction processing is performed. Thereafter, the front end of the top side of the sheet S reaches the position of the front end detection sensor 423 (t7), and the front end correction processing is performed. In the front end correction processing, the conveying speed “V process” and the acceleration timing of the driving roller 372 are determined on the basis of the information on a time until the image carried on the intermediate transfer belt 34 and directed toward the secondary transfer part 35 reaches the secondary transfer part 35 and the information on the time when the front end of the sheet S fed toward the secondary transfer part 35 by the driving roller 372 reaches the front end detection sensor 423.

Then, the front end of the top side of the sheet S reaches the position of the front end detection sensor 423 (t7), and the front end correction is started at t8 when a counter (not illustrated) for measuring the acceleration timing determined in the front end correction processing times up. Then at time t9 after the front end correction is made, the sheet S reaches the secondary transfer position.

The front end of the top side of the sheet S then reaches the position where the sheet edge detection sensor 424 is arranged (t10), and the first measurement of the front edges (t10), the second measurement thereof (t11), the first measurement of the rear edges (t12), and the second measurement thereof (t13) are made. The control part 100 then determines whether the formed image rotation correction needs to be made on the basis of the measurement results. Thereafter, a next job as a top-side image forming instruction is input into the image forming part 30 (t14).

Further, the first bend correction of the back side of the sheet S by the rollers 372A and 372B configuring the driving roller 372 is made at time t15 when the front end of the back side of the sheet S passes through the first bend detection sensor 420. The first bend correction of the back side of the sheet S is made by the rollers 372A and 372B until t16 to t17 after the first bend correction is made. Here, the conveying speed is decreased from “V sheet feeding” to “V bend 2.”

On the other hand, the front end of the back side of the sheet S reaches the position of the second bend detection sensor 421 (t17). The second bend correction without the resist of the back side of the sheet S is started at time t18, and then the front end of the sheet S subjected to the second bend correction reaches the position where the deviation detection sensor 422 is arranged at t19. The deviation correction processing is performed at time t19. The front end of the back side of the sheet S subjected to the deviation correction processing reaches the position where the front end detection sensor 423 is arranged at time t20. The front end correction is then started at t21 when the counter (not illustrated) for measuring “V process” and the acceleration timing determined in the front end correction processing times up. Then at time t22 after the front end correction is made, the sheet S reaches the secondary transfer position. The sheet S reaching the secondary transfer position at time t22 is a sheet onto which the top-side image is transferred at time t1.

<Others>

The first and second embodiments have described the example in which the bend corrections are made during double-sided printing, but the bend correction methods according to the embodiments of the present invention are of course applicable to single-sided printing.

The description has been made assuming that the stepping motors are employed for the conveying motors as roller drive mechanisms, but roller drive mechanisms with variable drive resolution are possible. For example, a direct linear motor or the like may be employed for the roller drive mechanisms.

The present invention is not limited to the above embodiments, and can employ other various applications and variants without departing from the spirit of the present invention described in the claims.

For example, the above embodiments describe the configurations of the apparatus and the system in detail and specifically in order to clearly explain the present invention, and are not necessarily limited to ones including all the described components. Part of the configuration of an embodiment may be replaced with a component of other embodiment. Further, the configuration of an embodiment may be added with a component of other embodiment. Furthermore, part of the configuration of each embodiment may be added with other component, deleted, or replaced therewith.

Part or all of the above components, functions, processing parts, processing units, and the like may be realized in hardware by a design of an integrated circuit, for example. A processor such as central processing unit (CPU) interprets and executes the programs realizing the respective functions so that each of the above components and functions may be realized in software. The information on the programs, tables, and files realizing each function may be stored in a recording apparatus such as the memory 105, hard disc, and solid state drive (SSD), or a recording medium such as IC card, SD card, and DVD.

The control lines or information lines, which are regarded as necessary for description, are illustrated, and all the control lines or information lines are not necessarily illustrated for products. Almost all the components may be regarded as actually interconnected.

Although embodiments of the present invention have been described and illustrated in detail, the disclosed embodiments are made for purposes of illustration and example only and not limitation. The scope of the present invention should be interpreted by terms of the appended claims

What is claimed is:

1. An image forming apparatus comprising:
an image forming part that forms an image on a sheet conveyed in a conveying path;
a transfer part that transfers the image formed by the image forming part onto the sheet;
a conveying roller that is arranged at the upstream of the transfer part in the conveying path, has a plurality of rollers arranged side by side in a direction orthogonal to a conveying direction of the sheet, and conveys the sheet to the transfer part;
a plurality of roller drive mechanisms that independently rotate the rollers constituting the conveying roller;
a first bend detection sensor that is arranged in the conveying path and detects a bend of a front end of the sheet relative to the conveying direction;
a sheet rotation angle calculation part that calculates a first rotation offset angle of the front end of the sheet relative to an axial line of the conveying roller by use of the detection result of the first bend detection sensor;
a roller driving amount calculation part that calculates the respective driving amounts of the roller drive mechanisms on the basis of the first rotation offset angle of the sheet calculated by the rotation angle calculation part such that the bend of the sheet relative to the conveying direction is corrected; and
a drive mechanism control part that controls operations of the roller drive mechanisms on the basis of the respective driving amounts of the roller drive mechanisms calculated on the basis of the first rotation offset angle of the sheet,
wherein the drive mechanism control part controls such that a drive resolution of the roller drive mechanisms is different between a conveying operation not during a bend correction operation and a conveying operation during a bend correction operation for first bend correction of controlling the operations of the roller drive mechanisms on the basis of the first rotation offset angle of the sheet.

2. The image forming apparatus according to claim 1,
wherein a set value of the drive resolution in a conveying operation during the bend correction operation is higher than a set value of the drive resolution in a conveying operation not during the bend correction operation.

3. The image forming apparatus according to claim 1, further comprising:
a second bend detection sensor that is arranged at the downstream of the first bend detection sensor in the conveying path and detects a bend of a front end of the sheet relative to the conveying direction,
wherein the sheet rotation angle calculation part calculates a second rotation offset angle of the front end of the sheet relative to an axial line of the conveying roller on the basis of the detection result of the second bend detection sensor,
the roller driving amount calculation part calculates the respective driving amounts of the roller drive mechanisms on the basis of the second rotation offset angle of the sheet such that a bend of the sheet relative to the conveying direction is corrected, and
the drive mechanism control part controls such that a drive resolution of the roller drive mechanisms is different between a conveying operation during the first bend correction and a conveying operation during second bend correction for the second bend correction of controlling the operations of the roller drive mechanisms on the basis of the respective driving amounts of the roller drive mechanisms calculated on the basis of the second rotation offset angle of the sheet.

4. The image forming apparatus according to claim 3,
wherein the drive resolutions during the first bend correction and the second bend correction are switched without stopping rotation of the conveying roller.

5. The image forming apparatus according to claim 3,
wherein a set value of the drive resolution in a conveying operation during the second bend correction is higher than a set value of the drive resolution in a conveying operation during the first bend correction.

6. The image forming apparatus according to claim 3, further comprising:
a front end detection sensor that is arranged at the downstream of the second bend detection sensor in the conveying path and detects a front end of the sheet,
wherein assuming a conveying speed when a front edge of the sheet reaches the first bend detection sensor as sheet feeding speed, a conveying speed when a front edge of the sheet reaches the second bend detection sensor and a conveying speed when the second bend correction operation is completed as bend correction speeds, a conveying speed when a front edge of the sheet reaches the front end detection sensor as front end speed, and a process linear speed during transfer in the transfer part as process speed,
a relationship of the speeds is (sheet feeding speed)>(front end speed)>(process speed)>(bend correction speeds).

7. The image forming apparatus according to claim 3,
wherein the drive mechanism control part switches the drive resolution of the roller drive mechanisms to the drive resolution during the first bend correction again after the second bend correction is completed and before the conveying speed of the sheet is increased toward the transfer part.

8. The image forming apparatus according to claim 3,
wherein the drive mechanism control part conveys the sheet at the same bend correction speed as the conveying speed during the second bend correction after the second bend correction is completed and until the conveying speed of the sheet is increased toward the transfer part, and not to stop the sheet.

9. The image forming apparatus according to claim 3,
wherein the drive mechanism control part switches a phase excitation method of the roller drive mechanisms during the first bend correction and the second bend correction so that the drive resolution is different.

10. The image forming apparatus according to claim 1,
wherein each of the roller drive mechanisms is a stepping motor.

11. The image forming apparatus according to claim 1, further comprising:
a fixing part that fixes a transferred image on the sheet;
a double-sided path that branches at the downstream of the fixing part in the conveying path and joins up at the upstream of the conveying roller;
an inversion part that is arranged in the double-sided path and inverts a front end and a rear end of the sheet passing through the image forming part in the conveying direction to feed the sheet;
a sheet edge detection sensor that is arranged in the double-sided path and detects bends of the front edge and the rear edge of the sheet relative to the conveying direction; and
a parallelism offset angle calculation part that calculates a parallelism offset angle between the front edge and the rear edge of the sheet on the basis of the detection result of the sheet edge detection sensor,
wherein the first bend detection sensor is arranged at the downstream of the point where the conveying path and the double-sided path join up in the conveying path,
the parallelism offset angle calculation part calculates a rotation offset angle of the sheet, and a parallelism offset angle between the front edge and the rear edge of the sheet on the basis of the detection results of the front edge and the rear edge of the sheet by the sheet edge detection sensor, and
the roller driving amount calculation part controls such that the rear edge of the sheet is parallel with an image during back-side printing assuming a difference between the bend amount of the front edge of the sheet by the sheet edge detection sensor and the bend amount of the front end of the sheet by the first bend detection sensor or the second bend detection sensor as a change in the bend amount of the sheet during back-side printing relative to the sheet during top-side printing in double-sided printing such that the parallelism offset angle detected by the sheet edge detection sensor is compensated for by the bend correction amount of the sheet when the first bend detection sensor or the second bend detection sensor detects a bend of the front end of the sheet joining up with the conveying path from the double-sided path to make the first bend correction or the second bend correction.

12. The image forming apparatus according to claim 1,
wherein the first bend detection sensor is arranged at the downstream of the conveying rollers in the conveying path.

13. The image forming apparatus according to claim 11,
wherein the sheet edge detection sensor is arranged at the downstream of the inversion part in the double-sided path.
